(19) United States
(12) Patent Application Publication
(10) Pub. No.: US 2025/0087395 A1
(43) Pub. Date: Mar. 13, 2025

(54) MAGNETORHEOLOGICAL EMULSIONS AND METHODS OF MAKING AND USE THEREOF

(71) Applicant: The Board of Trustees of The University of Alabama, Tuscaloosa, AL (US)

(72) Inventors: Amanda Koh, Tuscaloosa, AL (US); Emmanual Johnson, Tuscaloosa, AL (US); Sandhiya Thiagarajan, Tuscaloosa, AL (US)

(21) Appl. No.: 18/770,905

(22) Filed: Jul. 12, 2024

Related U.S. Application Data
(60) Provisional application No. 63/538,138, filed on Sep. 13, 2023.

(51) Int. Cl. H01F 1/44

(52) U.S. Cl. CPC H01F 1/447

(57) ABSTRACT

The disclosed subject matter relates to magnetorheological emulsions and methods of making and use thereof. For example, disclosed herein are magnetorheological emulsions comprising: a magnetorheological fluid comprising a plurality of magnetic particles dispersed in a non-magnetic carrier fluid; and a plurality of discrete emulsion droplets dispersed in the non-magnetic carrier fluid; wherein each of the plurality of discrete emulsion droplets comprises an emulsifier encapsulating an internal fluid phase; wherein the internal fluid phase and the non-magnetic carrier fluid are immiscible.

### CROSS-REFERENCE TO RELATED APPLICATIONS

This application claims the benefit of priority to U.S. Provisional Application No. 63/538,138 filed Sep. 13, 2023, which is hereby incorporated herein by reference in its entirety.

### STATEMENT OF GOVERNMENT SUPPORT

This invention was made with government support under Grant No. 2212116 awarded by the National Science Foundation. The government has certain rights in the invention.

### BACKGROUND

Magnetorheological fluids (MRFs) are simple suspensions of magnetic particles in a non-magnetic carrier fluid. MRFs are unique in their ability to quickly transition from a liquid to almost solid-like state upon the application of an external magnetic field. MRFs have great promise but haven't found full translation into various markets due to challenges related to the energy requirements of the material. In order to improve MRF performance, specifically increase the final viscosity or yield stress of the MRF, the simplest method is to increase magnetic field. However, increasing magnetic field requires greater power, which may be impractical under a variety of circumstances. New methods are needed to reduce the power requirement of MRFs while still achieving their impressive performance. The compositions and methods discussed herein address these and other needs.

### SUMMARY

In accordance with the purposes of the disclosed compositions and methods as embodied and broadly described herein, the disclosed subject matter relates to magnetorheological emulsions and methods of making and use thereof.

For example, disclosed herein are magnetorheological emulsions comprising: a magnetorheological fluid comprising a plurality of magnetic particles dispersed in a non-magnetic carrier fluid; and a plurality of discrete emulsion droplets dispersed in the non-magnetic carrier fluid; wherein each of the plurality of discrete emulsion droplets comprises an emulsifier encapsulating an internal fluid phase; wherein the internal fluid phase and the non-magnetic carrier fluid are immiscible.

In some examples, the magnetorheological emulsion comprises: from greater than 0 to less than 100 vol % of the non-magnetic carrier fluid; from greater than 0 to 25 vol % of the plurality of magnetic particles; from greater than 0 to 25 vol % of the emulsifier; and from greater than 0 to less than 100 vol % of the internal fluid phase.

In some examples, the magnetorheological emulsion comprises from 0.1 to 2.5 vol %, such as 1 vol %, of the plurality of magnetic particles.

In some examples, the magnetorheological emulsion comprises from 0.1 to 10 vol % of the emulsifier.

In some examples, the magnetorheological emulsion comprises from 10 to 80 vol %, such as 40 vol %, of the internal fluid phase.

In some examples, the magnetorheological emulsion comprises: from greater than 0 to less than 100 vol % of the non-magnetic carrier fluid; from 0.1 to 2.5 vol %, such as 1 vol %, of the plurality of magnetic particles; from greater than 0 to 25 vol % of the emulsifier; and from greater than 0 to less than 100 vol % of the internal fluid phase.

In some examples, the magnetorheological emulsion comprises: from greater than 0 to less than 100 vol % of the non-magnetic carrier fluid; from greater than 0 to 25 vol % of the plurality of magnetic particles; from 0.1 to 10 vol % of the emulsifier; and from greater than 0 to less than 100 vol % of the internal fluid phase.

In some examples, the magnetorheological emulsion comprises: from greater than 0 to less than 100 vol % of the non-magnetic carrier fluid; from greater than 0 to 25 vol % of the plurality of magnetic particles; from greater than 0 to 25 vol % of the emulsifier; and from 10 to 80 vol %, such as 40 vol %, of the internal fluid phase.

In some examples, the magnetorheological emulsion comprises: from greater than 0 to less than 100 vol % of the non-magnetic carrier fluid; from 0.1 to 2.5 vol %, such as 1 vol %, of the plurality of magnetic particles; from 0.1 to 10 vol % of the emulsifier; and from greater than 0 to less than 100 vol % of the internal fluid phase.

In some examples, the magnetorheological emulsion comprises: from greater than 0 to less than 100 vol % of the non-magnetic carrier fluid; from 0.1 to 2.5 vol %, such as 1 vol %, of the plurality of magnetic particles; from greater than 0 to 25 vol % of the emulsifier; and from 10 to 80 vol %, such as 40 vol %, of the internal fluid phase.

In some examples, the magnetorheological emulsion comprises: from greater than 0 to less than 100 vol % of the non-magnetic carrier fluid; from greater than 0 to 25 vol % of the plurality of magnetic particles; from 0.1 to 10 vol % of the emulsifier; and from 10 to 80 vol %, such as 40 vol %, of the internal fluid phase.

In some examples, the magnetorheological emulsion comprises: from greater than 0 to less than 100 vol % of the non-magnetic carrier fluid; from 0.1 to 2.5 vol %, such as 1 vol %, of the plurality of magnetic particles; from 0.1 to 10 vol % of the emulsifier; and from 10 to 80 vol %, such as 40 vol %, of the internal fluid phase.

In some examples, the plurality of magnetic particles comprise iron. In some examples, the plurality of magnetic particles comprise an iron oxide. In some examples, the plurality of magnetic particles are substantially spherical in shape. In some examples, the plurality of magnetic particles have an average particle size of from 0.01 to 100 micrometers.

In some examples, the non-magnetic carrier fluid comprises mineral oil, almond oil, decane, silicone oil, or water. In some examples, the non-magnetic carrier fluid comprises mineral oil, silicone oil, or water. In some examples, the non-magnetic carrier fluid can have a fluid viscosity of from 0.9 cP to 1×10⁶ cP.

In some examples, the internal fluid phase comprises mineral oil, almond oil, decane, silicone oil, limonene, or water. In some examples, the internal fluid phase comprises mineral oil, silicone oil, or water.

In some examples, the non-magnetic carrier fluid comprises water and the internal fluid phase comprises mineral oil and/or silicone oil.

In some examples, the non-magnetic carrier fluid comprises mineral oil and/or silicone oil and the internal fluid phase comprises water.

In some examples, the plurality of discrete emulsion droplets have an average droplet size of from 0.1 micrometers (microns, μm) to 100 μm, such as from 1 to 100 μm. In some examples, the plurality of discrete emulsion droplets have an average droplet size of from 0.1 μm to 50 μm, such as from 1 μm to 10 μm.

In some examples, the emulsifier comprises a surfactant. In some examples, the emulsifier comprises a nonionic surfactant. In some examples, the emulsifier comprises a detergent. In some examples, the emulsifier comprises soy lecithin, sodium stearoyl lactylate, triton X-100, sorbitan monolaurate, or a combination thereof.

In some examples, the emulsifier comprises a Pickering emulsifier, the Pickering emulsifier comprising a plurality of non-magnetic particles.

In some examples, in the presence of a magnetic field, the magnetorheological emulsion exhibits a yield stress that is greater than the yield stress of the magnetorheological fluid in the absence of the plurality of discrete emulsion droplets under conditions that are otherwise the same.

In some examples, in the absence of a magnetic field, the magnetorheological emulsion has a fluid viscosity of from 0.9 cP to 1×10⁶ cP.

Also disclosed herein are methods of use of any of the magnetorheological emulsions disclosed herein. In some examples, the method comprises using the magnetorheological emulsion in a magnetorheological device (e.g., in place of a magnetorheological fluid). In some examples, the method comprises using the magnetorheological emulsion in a magnetorheological damper, such as in an earthquake damper, a prosthetic device, a robotic device, or a combination thereof. In some examples, the method comprises using the magnetorheological emulsion in an actuator, such as in a robot or a robotic component.

Also disclosed herein are methods of making any of the magnetorheological emulsions disclosed herein. In some examples, the method comprises dispersing the plurality of discrete emulsion droplets and the plurality of magnetic particles in the non-magnetic carrier fluid.

In some examples, the method comprises: contacting the non-magnetic carrier fluid, the emulsifier, and the internal fluid phase to form a first composition; agitating the first composition to form a first dispersion comprising the plurality of discrete emulsion droplets dispersed in the non-magnetic carrier fluid (e.g., a first emulsion); contacting the plurality of magnetic particles with the first dispersion to form a second composition; and agitating the second composition to form the magnetorheological emulsion. In some examples, agitating the first composition and/or the second composition comprises using a high shear homogenizer, a vortex, or a combination thereof. In some examples, the first composition is agitated for an amount of time of from 1 minute to 1 hour, such as from 5 minutes to 1 hour. In some examples, the second composition is agitated for an amount of time of from 1 second to 5 minutes, such as 30 seconds. In some examples, the first composition is agitated for an amount of time of from 1 minute to 1 hour, such as from 5 minutes to 1 hour, and the second composition is agitated for an amount of time of from 1 second to 5 minutes, such as 30 seconds.

Additional advantages of the disclosed compositions and methods will be set forth in part in the description which follows, and in part will be obvious from the description. The advantages of the disclosed compositions and methods will be realized and attained by means of the elements and combinations particularly pointed out in the appended claims. It is to be understood that both the foregoing general description and the following detailed description are exemplary and explanatory only and are not restrictive of the disclosed compositions and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1A. MRF comprising a dispersion of iron in silicone oil in the “off-state.”

FIG. 1B. MRF of FIG. 1A in the “on-state,” ˜10 seconds of applying magnetic field.

FIG. 2. Schematic illustration of three MRFs states: the “off-state” (left), the “on-state” (middle), and the “yielded on-state” (right).

FIG. 3. Fitted Herschel-Bulkley yield stress for MRFs with and without emulsion droplets included as a function of magnetic field: neat iron dispersion in water (triangles), MRF with small discrete emulsion droplets (squares), and MRF with large discrete emulsion droplets (circles).

FIG. 4. Microscopy image of magnetorheological fluid with emulsion droplets (1 vol % Fe, 40 vol % Mineral oil, 0.1% Triton X-100) corresponding to the circle data points in FIG. 3. Scale bars: 100 micrometers.

FIG. 5. Microscopy image of magnetorheological fluid with emulsion droplets (1 vol % Fe, 40 vol % Mineral oil, 1% Triton X-100) corresponding to the square data points in FIG. 3. Scale bars: 100 micrometers.

FIG. 6. Summary of MREm parameters investigated.

FIG. 7. Dimensionless numbers used to described emulsion and MRF behavior as well as the common parameters of interest.

FIG. 8. Interfacial rheology configuration.

FIG. 9. 1 vol % iron almond oil MREm rheology at 0 T.

FIG. 10. 1 vol % iron almond oil MREm rheology at 0.1 T.

FIG. 11. 10 vol % iron almond oil MREm rheology at 0 T.

FIG. 12. 10 vol % iron almond oil MREm rheology at 0.1 T.

### DETAILED DESCRIPTION

The compositions and methods described herein may be understood more readily by reference to the following detailed description of specific aspects of the disclosed subject matter and the Examples included therein.

Before the present compositions and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps. As used in the specification and in the claims, the term “comprising” can include the aspects “consisting of” and “consisting essentially of.”

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

When the specific values are disclosed between two end values, it is understood that these end values can also be included.

For the terms “for example” and “such as,” and grammatical equivalences thereof, the phrase “and without limitation” is understood to follow unless explicitly stated otherwise. It is further understood that these phrases are not used in a restrictive sense, but for explanatory purposes. “Exemplary” means “an example of” and is not intended to convey an indication of a preferred or ideal embodiment.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

As used herein, the term “and/or” includes any and all combinations of one or more of the associated listed items.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

The expressions “ambient temperature” and “room temperature” as used herein are understood in the art and refer generally to a temperature from about 20° C. to about 35° C.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight of component Y, components X and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

A volume percent (vol %) of a component, unless specifically stated to the contrary, is based on the total volume of the formulation or composition in which the component is included.

It is understood that the term “salt,” as used herein, refers to a chemical compound that can be formed form a reaction between an acid and a base. It is understood that the term “salt,” as used herein, encompasses both inorganic and organic salts capable of providing the desired properties to the composition. In still further aspects, a cation of the disclosed herein salts is a metal cation.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

Unless otherwise defined, all technical and scientific terms used herein have the same meaning as commonly understood by one of ordinary skill in the art to which this invention belongs.

“Phase,” as used herein, generally refers to a region of a material having a substantially uniform composition which is a distinct and physically separate portion of a heterogeneous system. The term “phase” does not imply that the material making up a phase is a chemically pure substance, but merely that the chemical and/or physical properties of the material making up the phase are essentially uniform throughout the material, and that these chemical and/or physical properties differ significantly from the chemical and/or physical properties of another phase within the material. Examples of physical properties include density, thickness, aspect ratio, specific surface area, porosity, and dimensionality. Examples of chemical properties include chemical composition.

By “continuous” it is meant a phase such that all points within the phase are directly connected, so that for any two points within a continuous phase there exists a path which connects the two points and does not leave the phase.

As used herein, “molecular weight” refers to number average molecular weight as measured by ¹H NMR spectroscopy, unless indicated otherwise.

The organic moieties mentioned when defining variable positions within the general formulae described herein (e.g., the term “halogen”) are collective terms for the individual substituents encompassed by the organic moiety. The prefix Cn-Cm preceding a group or moiety indicates, in each case, the possible number of carbon atoms in the group or moiety that follows.

The term “ion,” as used herein, refers to any molecule, portion of a molecule, cluster of molecules, molecular complex, moiety, or atom that contains a charge (positive, negative, or both at the same time within one molecule, cluster of molecules, molecular complex, or moiety (e.g., zwitterions)) or that can be made to contain a charge. Methods for producing a charge in a molecule, portion of a molecule, cluster of molecules, molecular complex, moiety, or atom are disclosed herein and can be accomplished by methods known in the art, e.g., protonation, deprotonation, oxidation, reduction, alkylation, acetylation, esterification, de-esterification, hydrolysis, etc.

The term “anion” is a type of ion and is included within the meaning of the term “ion.” An “anion” is any molecule, portion of a molecule (e.g., zwitterion), cluster of molecules, molecular complex, moiety, or atom that contains a net negative charge or that can be made to contain a net negative charge. The term “anion precursor” is used herein to specifically refer to a molecule that can be converted to an anion via a chemical reaction (e.g., deprotonation).

The term “cation” is a type of ion and is included within the meaning of the term “ion.” A “cation” is any molecule, portion of a molecule (e.g., zwitterion), cluster of molecules, molecular complex, moiety, or atom, that contains a net positive charge or that can be made to contain a net positive charge. The term “cation precursor” is used herein to specifically refer to a molecule that can be converted to a cation via a chemical reaction (e.g., protonation or alkylation).

### Magnetorheological Emulsions

Disclosed herein are magnetorheological emulsions comprising: a magnetorheological fluid comprising a plurality of magnetic particles dispersed in a non-magnetic carrier fluid; and a plurality of discrete emulsion droplets dispersed in the non-magnetic carrier fluid; wherein each of the plurality of discrete emulsion droplets comprises an emulsifier encapsulating an internal fluid phase; and wherein the internal fluid phase and the non-magnetic carrier fluid are immiscible.

In some examples, the magnetorheological emulsion comprises greater than 0 vol % of the non-magnetic carrier fluid (e.g., 0.1 vol % or more, 0.25 vol % or more, 0.5 vol % or more, 0.75 vol % or more, 1 vol % or more, 1.5 vol % or more, 2 vol % or more, 2.5 vol % or more, 3 vol % or more, 3.5 vol % or more, 4 vol % or more, 4.5 vol % or more, 5 vol % or more, 6 vol % or more, 7 vol % or more, 8 vol % or more, 9 vol % or more, 10 vol % or more, 15 vol % or more, 20 vol % or more, 25 vol % or more, 30 vol % or more, 35 vol % or more, 40 vol % or more, 45 vol % or more, 50 vol % or more, 55 vol % or more, 60 vol % or more, 65 vol % or more, 70 vol % or more, 75 vol % or more, 80 vol % or more, 85 vol % or more, 90 vol % or more, or 95 vol % or more). In some examples, the magnetorheological emulsion comprises less than 100 vol % of the non-magnetic carrier fluid (e.g., 99 vol % or less, 95 vol % or less, 90 vol % or less, 85 vol % or less, 80 vol % or less, 75 vol % or less, 70 vol % or less, 65 vol % or less, 60 vol % or less, 55 vol % or less, 50 vol % or less, 45 vol % or less, 40 vol % or less, 35 vol % or less, 30 vol % or less, 25 vol % or less, 20 vol % or less, 15 vol % or less, 10 vol % or less, 9 vol % or less, 8 vol % or less, 7 vol % or less, 6 vol % or less, 5 vol % or less, 4.5 vol % or less, 4 vol % or less, 3.5 vol % or less, 3 vol % or less, 2.5 vol % or less, 2 vol % or less, 1.5 vol % or less, 1 vol % or less, 0.75 vol % or less, or 0.5 vol % or less). The vol % of the non-magnetic carrier fluid in the magnetorheological emulsion can range from any of the minimum values described above to any of the maximum values described above. For example, the magnetorheological emulsion can comprises from greater than 0 to less than 100 vol % of the non-magnetic carrier fluid (e.g., from greater than 0 vol % to 50 vol %, from 50 vol % to less than 100 vol %, from greater than 0 vol % to 20 vol %, from 20 vol % to 40 vol %, from 40 vol % to 60 vol %, from 60 vol % to 80 vol %, from 80 vol % to less than 100 vol %, from greater than 0 vol % to 99 vol %, from greater than 0 vol % to 90 vol %, from greater than 0 vol % to 80 vol %, from greater than 0 vol % to 60 vol %, from greater than 0 vol % to 40 vol %, from greater than 0 vol % to 10 vol %, from 0.1 vol % to less than 100 vol %, from 0.5 vol % to less than 100 vol %, from 1 vol % to less than 100 vol %, from 5 vol % to less than 100 vol %, from 10 vol % to less than 100 vol %, from 20 vol % to less than 100 vol %, from 40 vol % to less than 100 vol %, from 60 vol % to less than 100 vol %, from 0.1 vol % to 99 vol %, from 1 vol % to 95 vol %, or from 10 vol % to 90 vol %).

In some examples, the magnetorheological emulsion comprises greater than 0 vol % of the plurality of magnetic particles (e.g., 0.1 vol % or more, 0.25 vol % or more, 0.5 vol % or more, 0.75 vol % or more, 1 vol % or more, 1.5 vol % or more, 2 vol % or more, 2.5 vol % or more, 3 vol % or more, 3.5 vol % or more, 4 vol % or more, 4.5 vol % or more, 5 vol % or more, 6 vol % or more, 7 vol % or more, 8 vol % or more, 9 vol % or more, 10 vol % or more, 15 vol % or more, or 20 vol % or more). In some examples, the magnetorheological emulsion comprises 25 vol % or less of the plurality of magnetic particles (e.g., 20 vol % or less, 15 vol % or less, 10 vol % or less, 9 vol % or less, 8 vol % or less, 7 vol % or less, 6 vol % or less, 5 vol % or less, 4.5 vol % or less, 4 vol % or less, 3.5 vol % or less, 3 vol % or less, 2.5 vol % or less, 2 vol % or less, 1.5 vol % or less, 1 vol % or less, 0.75 vol % or less, or 0.5 vol % or less). The vol % of the plurality of magnetic particles in the magnetorheological emulsion can range from any of the minimum values described above to any of the maximum values described above. For example, the magnetorheological emulsion can comprises from greater than 0 to 25 vol % of the plurality of magnetic particles (e.g., from greater than 0 vol % to 12.5 vol %, from 12.5 vol % to 25 vol %, from greater than 0 vol % to 5 vol %, from 5 vol % to 10 vol %, from 10 vol % to 15 vol %, from 15 vol % to 20 vol %, from 20 vol % to 25 vol %, from greater than 0 vol % to 20 vol %, from greater than 0 vol % to 15 vol %, from greater than 0 vol % to 10 vol %, from 0.1 vol % to 25 vol %, from 0.5 vol % to 25 vol %, from 1 vol % to 25 vol %, from 5 vol % to 25 vol %, from 10 vol % to 25 vol %, from 15 vol % to 25 vol %, from 0.1 vol % to 20 vol %, or from 0.5 vol % to 10 vol %). In some examples, the magnetorheological emulsion comprises from 0.1 to 2.5 vol %, such as 1 vol %, of the plurality of magnetic particles.

In some examples, the magnetorheological emulsion comprises greater than 0 vol % of the emulsifier (e.g., 0.1 vol % or more, 0.25 vol % or more, 0.5 vol % or more, 0.75 vol % or more, 1 vol % or more, 1.5 vol % or more, 2 vol % or more, 2.5 vol % or more, 3 vol % or more, 3.5 vol % or more, 4 vol % or more, 4.5 vol % or more, 5 vol % or more, 6 vol % or more, 7 vol % or more, 8 vol % or more, 9 vol % or more, 10 vol % or more, 15 vol % or more, or 20 vol % or more). In some examples, the magnetorheological emulsion comprises 25 vol % or less of the emulsifier (e.g., 20 vol % or less, 15 vol % or less, 10 vol % or less, 9 vol % or less, 8 vol % or less, 7 vol % or less, 6 vol % or less, 5 vol % or less, 4.5 vol % or less, 4 vol % or less, 3.5 vol % or less, 3 vol % or less, 2.5 vol % or less, 2 vol % or less, 1.5 vol % or less, 1 vol % or less, 0.75 vol % or less, or 0.5 vol % or less). The vol % of the emulsifier in the magnetorheological emulsion can range from any of the minimum values described above to any of the maximum values described above. For example, the magnetorheological emulsion can comprises from greater than 0 to 25 vol % of the emulsifier (e.g., from greater than 0 vol % to 12.5 vol %, from 12.5 vol % to 25 vol %, from greater than 0 vol % to 5 vol %, from 5 vol % to 10 vol %, from 10 vol % to 15 vol %, from 15 vol % to 20 vol %, from 20 vol % to 25 vol %, from greater than 0 vol % to 20 vol %, from greater than 0 vol % to 15 vol %, from greater than 0 vol % to 10 vol %, from 0.1 vol % to 25 vol %, from 0.5 vol % to 25 vol %, from 1 vol % to 25 vol %, from 5 vol % to 25 vol %, from 10 vol % to 25 vol %, from 15 vol % to 25 vol %, from 0.1 vol % to 20 vol %, or from 0.5 vol % to 10 vol %). In some examples, the magnetorheological emulsion comprises from 0.1 to 10 vol % of the emulsifier.

In some examples, the magnetorheological emulsion comprises greater than 0 vol % of the internal fluid phase (e.g., 0.1 vol % or more, 0.25 vol % or more, 0.5 vol % or more, 0.75 vol % or more, 1 vol % or more, 1.5 vol % or more, 2 vol % or more, 2.5 vol % or more, 3 vol % or more, 3.5 vol % or more, 4 vol % or more, 4.5 vol % or more, 5 vol % or more, 6 vol % or more, 7 vol % or more, 8 vol % or more, 9 vol % or more, 10 vol % or more, 15 vol % or more, 20 vol % or more, 25 vol % or more, 30 vol % or more, 35 vol % or more, 40 vol % or more, 45 vol % or more, 50 vol % or more, 55 vol % or more, 60 vol % or more, 65 vol % or more, 70 vol % or more, 75 vol % or more, 80 vol % or more, 85 vol % or more, 90 vol % or more, or 95 vol % or more). In some examples, the magnetorheological emulsion comprises less than 100 vol % of the internal fluid phase (e.g., 99 vol % or less, 95 vol % or less, 90 vol % or less, 85 vol % or less, 80 vol % or less, 75 vol % or less, 70 vol % or less, 65 vol % or less, 60 vol % or less, 55 vol % or less, 50 vol % or less, 45 vol % or less, 40 vol % or less, 35 vol % or less, 30 vol % or less, 25 vol % or less, 20 vol % or less, 15 vol % or less, 10 vol % or less, 9 vol % or less, 8 vol % or less, 7 vol % or less, 6 vol % or less, 5 vol % or less, 4.5 vol % or less, 4 vol % or less, 3.5 vol % or less, 3 vol % or less, 2.5 vol % or less, 2 vol % or less, 1.5 vol % or less, 1 vol % or less, 0.75 vol % or less, or 0.5 vol % or less). The vol % of the internal fluid phase in the magnetorheological emulsion can range from any of the minimum values described above to any of the maximum values described above. For example, the magnetorheological emulsion can comprises from greater than 0 to less than 100 vol % of the internal fluid phase (e.g., from greater than 0 vol % to 50 vol %, from 50 vol % to less than 100 vol %, from greater than 0 vol % to 20 vol %, from 20 vol % to 40 vol %, from 40 vol % to 60 vol %, from 60 vol % to 80 vol %, from 80 vol % to less than 100 vol %, from greater than 0 vol % to 99 vol %, from greater than 0 vol % to 90 vol %, from greater than 0 vol % to 80 vol %, from greater than 0 vol % to 60 vol %, from greater than 0 vol % to 40 vol %, from greater than 0 vol % to 10 vol %, from 0.1 vol % to less than 100 vol %, from 0.5 vol % to less than 100 vol %, from 1 vol % to less than 100 vol %, from 5 vol % to less than 100 vol %, from 10 vol % to less than 100 vol %, from 20 vol % to less than 100 vol %, from 40 vol % to less than 100 vol %, from 60 vol % to less than 100 vol %, from 0.1 vol % to 99 vol %, from 1 vol % to 95 vol %, or from 10 vol % to 90 vol %). In some examples, the magnetorheological emulsion comprises from 10 to 80 vol %, such as 40 vol %, of the internal fluid phase.

In some examples, the magnetorheological emulsion comprises: from greater than 0 to less than 100 vol % of the non-magnetic carrier fluid; from greater than 0 to 25 vol % of the plurality of magnetic particles; from greater than 0 to 25 vol % of the emulsifier; and from greater than 0 to less than 100 vol % of the internal fluid phase.

In some examples, the magnetorheological emulsion comprises: from greater than 0 to less than 100 vol % of the non-magnetic carrier fluid; from 0.1 to 2.5 vol %, such as 1 vol %, of the plurality of magnetic particles; from greater than 0 to 25 vol % of the emulsifier; and from greater than 0 to less than 100 vol % of the internal fluid phase.

In some examples, the magnetorheological emulsion comprises: from greater than 0 to less than 100 vol % of the non-magnetic carrier fluid; from greater than 0 to 25 vol % of the plurality of magnetic particles; from 0.1 to 10 vol % of the emulsifier; and from greater than 0 to less than 100 vol % of the internal fluid phase.

In some examples, the magnetorheological emulsion comprises: from greater than 0 to less than 100 vol % of the non-magnetic carrier fluid; from greater than 0 to 25 vol % of the plurality of magnetic particles; from greater than 0 to 25 vol % of the emulsifier; and from 10 to 80 vol %, such as 40 vol %, of the internal fluid phase.

In some examples, the magnetorheological emulsion comprises: from greater than 0 to less than 100 vol % of the non-magnetic carrier fluid; from 0.1 to 2.5 vol %, such as 1 vol %, of the plurality of magnetic particles; from 0.1 to 10 vol % of the emulsifier; and from greater than 0 to less than 100 vol % of the internal fluid phase.

In some examples, the magnetorheological emulsion comprises: from greater than 0 to less than 100 vol % of the non-magnetic carrier fluid; from 0.1 to 2.5 vol %, such as 1 vol %, of the plurality of magnetic particles; from greater than 0 to 25 vol % of the emulsifier; and from 10 to 80 vol %, such as 40 vol %, of the internal fluid phase.

In some examples, the magnetorheological emulsion comprises: from greater than 0 to less than 100 vol % of the non-magnetic carrier fluid; from greater than 0 to 25 vol % of the plurality of magnetic particles; from 0.1 to 10 vol % of the emulsifier; and from 10 to 80 vol %, such as 40 vol %, of the internal fluid phase.

In some examples, the magnetorheological emulsion comprises: from greater than 0 to less than 100 vol % of the non-magnetic carrier fluid; from 0.1 to 2.5 vol %, such as 1 vol %, of the plurality of magnetic particles; from 0.1 to 10 vol % of the emulsifier; and from 10 to 80 vol %, such as 40 vol %, of the internal fluid phase.

In some examples, in the presence of a magnetic field, the magnetorheological emulsion exhibits a yield stress that is greater than the yield stress of the magnetorheological fluid in the absence of the plurality of discrete emulsion droplets under conditions that are otherwise the same.

In some examples, in the absence of a magnetic field, the magnetorheological emulsion has a fluid viscosity of 0.9 cP or more (e.g., 1 cP or more, 5 cP or more, 10 cP or more, 50 cP or more, 100 cP or more, 500 cP or more, 1×10³ cP or more, 5×10³ cP or more, 1×10⁴ cP or more, 5×10⁴ cP or more, 1×10⁵ cP or more, or 5×10⁵ cP or more). In some examples, in the absence of a magnetic field, the magnetorheological emulsion has a fluid viscosity of 1×10⁶ cP or less (e.g., 5×10⁵ cP or less, 1×10⁵ cP or less, 5×10⁴ cP or less, 1×10⁴ cP or less, 5×10³ cP or less, 1×10³ cP or less, 500 cP or less, 100 cP or less, 50 cP or less, 10 cP or less, or 5 cP or less). The fluid viscosity of the magnetorheological emulsion in the absence of a magnetic field can range from any of the minimum values described above to any of the maximum values described above. For example, in the absence of a magnetic field, the magnetorheological emulsion has a fluid viscosity of from 0.9 cP to 1×10⁶ cP (e.g., from 0.9 cP to 1×10³ cP, from 1×10³ cP to 1×10⁶ cP, from 0.9 cP to 1×10² cP, from 1×10² cP to 1×10⁴ cP, from 1×10⁴ cP to 1×10⁶ cP, from 0.9 cP to 1×10⁵ cP, from 0.9 cP to 1×10⁴ cP, from 0.9 cP to 10 cP, from 1 cP to 1×10⁶ cP, from 10 cP to 1×10⁶ cP, from 100 cP to 1×10⁶ cP, from 1×10² cP to 1×10⁶ cP, from 1 to 1×10⁵, or from 10 to 1×10⁴).

### Plurality of Magnetic Particles

The plurality of magnetic particles can comprise any suitable magnetic particle (e.g., any suitable composition, size, and/or shape), such as those known in the art. The plurality of magnetic particles can comprise any suitable magnetic material, such as those known in the art. Such materials include, for example chromium dioxide; samarium cobalt alloys; iron powders, such as carbonyl iron powder, hematite, magnetite, gamma-Fe₂O₃, cobalt-treated iron oxides, and the like; and combinations thereof. In some examples, the magnetic material comprises a metal selected from the group consisting of Fe, Mn, Ni, Gd, Cu, Co, V, Zn, and combinations thereof. In some examples, the magnetic material comprises a metal selected from the group consisting of Fe, Mn, Ni, Gd, and combination thereof. In some examples, the magnetic material comprises iron. In some examples, the magnetic material comprises an iron oxide. In some examples, the plurality of magnetic particles comprise iron. In some examples, the plurality of magnetic particles comprise an iron oxide. In some example, the plurality of magnetic particles comprise Fe₂O₃, Fe₃O₄, or a combination thereof.

The plurality of magnetic particles can have an average particle size. “Average particle size” and “mean particle size” are used interchangeably herein, and generally refer to the statistical mean particle size of the particles in a population of particles. For example, the average particle size for a plurality of particles with a substantially spherical shape can comprise the average diameter of the plurality of particles. For a particle with a substantially spherical shape, the diameter of a particle can refer, for example, to the hydrodynamic diameter. As used herein, the hydrodynamic diameter of a particle can refer to the largest linear distance between two points on the surface of the particle. Mean particle size can be measured using methods known in the art, such as evaluation by scanning electron microscopy, transmission electron microscopy, and/or dynamic light scattering.

The plurality of magnetic particles can have an average particle size of 0.01 micrometers (microns, μm) or more (e.g., 0.025 μm or more, 0.05 μm or more, 0.075 μm or more, 0.1 μm or more, 0.25 μm or more, 0.5 μm or more, 0.75 μm or more, 1 μm or more, 1.25 μm or more, 1.5 μm or more, 1.75 μm or more, 2 μm or more, 2.5 μm or more, 3 μm or more, 3.5 μm or more, 4 μm or more, 4.5 μm or more, 5 μm or more, 6 μm or more, 7 μm or more, 8 μm or more, 9 μm or more, 10 μm or more, 11 μm or more, 12 μm or more, 13 μm or more, 14 μm or more, 15 μm or more, 16 μm or more, 17 μm or more, 18 μm or more, 19 μm or more, 20 μm or more, 25 μm or more, 30 μm or more, 35 μm or more, 40 μm or more, 45 μm or more, 50 μm or more, 55 μm or more, 60 μm or more, 65 μm or more, 70 μm or more, 75 μm or more, 80 μm or more, 85 μm or more, 90 μm or more, or 95 μm or more). In some examples, the plurality of magnetic particles can have an average particle size of 100 μm or less (e.g., 95 μm or less, 90 μm or less, 85 μm or less, 80 μm or less, 75 μm or less, 70 μm or less, 65 μm or less, 60 μm or less, 55 μm or less, 50 μm or less, 45 μm or less, 40 μm or less, 35 μm or less, 30 μm or less, 25 μm or less, 20 μm or less, 19 μm or less, 18 μm or less, 17 μm or less, 16 μm or less, 15 μm or less, 14 μm or less, 13 μm or less, 12 μm or less, 11 μm or less, 10 μm or less, 9 μm or less, 8 μm or less, 7 μm or less, 6 μm or less, 5 μm or less, 4.5 μm or less, 4 μm or less, 3.5 μm or less, 3 μm or less, 2.5 μm or less, 2 μm or less, 1.75 μm or less, 1.5 μm or less, 1.25 μm or less, 0.75 μm or less, 0.5 μm or less, 0.25 μm or less, 0.1 μm or less, 0.075 μm or less, or 0.05 μm or less). The average particle size of the plurality of magnetic particles can range from any of the minimum values described above to any of the maximum values described above. For example, the plurality of magnetic particles can have an average particle size of from 0.01 to 100 μm (e.g., from 0.01 μm to 50 μm, from 50 μm to 100 μm, from 0.01 μm to 20 μm, from 20 μm to 40 μm, from 40 μm to 60 μm, from 60 μm to 80 μm, from 80 μm to 100 μm, from 0.01 μm to 80 μm, from 0.01 μm to 60 μm, from 0.01 μm to 40 μm, from 0.01 μm to 10 μm, from 0.01 μm to 1 μm, from 0.1 μm to 100 μm, from 1 μm to 100 μm, from 10 μm to 100 μm, from 20 μm to 100 μm, from 40 μm to 100 μm, from 60 μm to 100 μm, from 0.025 μm to 80 μm, from 0.05 μm to 60 μm, from 0.075 μm to 40 μm, from 0.1 μm to 20 μm, or from 1 μm to 10 μm).

In some example, the plurality of magnetic particles can be substantially monodisperse. “Monodisperse” and “homogeneous size distribution,” as used herein, and generally describe a population of particles where all of the particles are the same or nearly the same size. As used herein, a monodisperse distribution refers to particle distributions in which 80% of the distribution (e.g., 85% of the distribution, 90% of the distribution, or 95% of the distribution) lies within 25% of the median particle size (e.g., within 20% of the median particle size, within 15% of the median particle size, within 10% of the median particle size, or within 5% of the median particle size).

The plurality of magnetic particles can comprise particles of any shape, such as a polyhedron (e.g., a platonic solid, a prism, a pyramid), a cylinder, a hemicylinder, an elliptical cylinder, a hemi-elliptical cylinder, a sphere, a hemisphere, a cone, a semicone, etc. In some examples, the plurality of magnetic particles can have a regular shape, an irregular shape, an isotropic shape, an anisotropic shape, or a combination thereof. In some examples, the plurality of magnetic particles can have an isotropic shape or an anisotropic shape. In some examples, the plurality of magnetic particles can have a shape that is substantially spherical.

### Non-Magnetic Carrier Fluid

The non-magnetic carrier fluid can comprise any suitable fluid, such as those known in the art.

For example, the non-magnetic carrier fluid can comprise an oil such as diesel oil, a refined mineral oil, a chemically modified mineral oil, a synthetic oil (such as synthetic paraffins, olefins, esters, acetals, or a combination of these), silicone oil, water, or a combination thereof. In some examples, the non-magnetic carrier fluid comprises mineral oil, almond oil, decane, silicone oil, water, ethylene glycol, polyethylene glycol, glycerol, alkane diol, ethanol, methanol, propanol, isopropanol, dimethyl sulfoxide (DMSO), acetonitrile, methylene chloride, or a combination thereof.

In some examples, the non-magnetic carrier fluid comprises mineral oil, almond oil, decane, silicone oil, or water. In some examples, the non-magnetic carrier fluid comprises mineral oil, silicone oil, or water.

In some examples, the non-magnetic carrier fluid can have a fluid viscosity of 0.9 cP or more (e.g., 1 cP or more, 5 cP or more, 10 cP or more, 50 cP or more, 100 cP or more, 500 cP or more, 1×10³ cP or more, 5×10³ cP or more, 1×10⁴ cP or more, 5×10⁴ cP or more, 1×10⁵ cP or more, or 5×10⁵ cP or more). In some examples, the non-magnetic carrier fluid has a fluid viscosity of 1×10⁶ cP or less (e.g., 5×10⁵ cP or less, 1×10⁵ cP or less, 5×10⁴ cP or less, 1×10⁴ cP or less, 5×10³ cP or less, 1×10³ cP or less, 500 cP or less, 100 cP or less, 50 cP or less, 10 cP or less, or 5 cP or less). The fluid viscosity of the non-magnetic carrier fluid can range from any of the minimum values described above to any of the maximum values described above. For example, the non-magnetic carrier fluid can have a fluid viscosity of from 0.9 cP to 1×10⁶ cP (e.g., from 0.9 cP to 1×10³ cP, from 1×10³ cP to 1×10⁶ cP, from 0.9 cP to 1×10² cP, from 1×10² cP to 1×10⁴ cP, from 1×10⁴ cP to 1×10⁶ cP, from 0.9 cP to 1×10⁵ cP, from 0.9 cP to 1×10⁴ cP, from 0.9 cP to 10 cP, from 1 cP to 1×10⁶ cP, from 10 cP to 1×10⁶ cP, from 100 cP to 1×10⁶ cP, from 1×10² cP to 1×10⁶ cP, from 1 to 1×10⁵, or from 10 to 1×10⁴).

### Internal Fluid Phase

The internal carrier fluid can comprise any suitable fluid, such as those known in the art.

For example, the internal carrier fluid can comprise an oil such as diesel oil, a refined mineral oil, a chemically modified mineral oil, a synthetic oil (such as synthetic paraffins, olefins, esters, acetals, or a combination of these), silicone oil, water, or a combination thereof. In some examples, the internal fluid phase comprises an alkane, a fatty acid based oil, an essential oil, or a combination thereof. In some examples, the internal fluid phase comprises mineral oil, almond oil, limonene, lemon oil, carene, hexadecane, decane, silicone oil, water, ethylene glycol, polyethylene glycol, glycerol, alkane diol, ethanol, methanol, propanol, isopropanol, dimethyl sulfoxide (DMSO), acetonitrile, methylene chloride, or a combination thereof. In some examples, the internal fluid phase comprises mineral oil, almond oil, decane, silicone oil, limonene, or water. In some examples, the internal fluid phase comprises mineral oil, silicone oil, or water.

In some examples, the non-magnetic carrier fluid comprises water and the internal fluid phase comprises mineral oil and/or silicone oil.

In some examples, the non-magnetic carrier fluid comprises mineral oil and/or silicone oil and the internal fluid phase comprises water.

### Plurality of Discrete Emulsion Droplets

In some examples, the plurality of discrete emulsion droplets can have an average droplet size. “Average droplet size” and “mean droplet size” are used interchangeably herein, and generally refer to the statistical mean droplet size of the droplets in a population of droplets. For example, the average droplet size for a plurality of droplets with a substantially spherical shape can comprise the average diameter of the plurality of droplets. For a droplet with a substantially spherical shape, the diameter of a droplet can refer, for example, to the hydrodynamic diameter. As used herein, the hydrodynamic diameter of a particle can refer to the largest linear distance between two points on the surface of the droplet. Mean droplet size can be measured using methods known in the art, such as evaluation by scanning electron microscopy, transmission electron microscopy, dynamic light scattering, laser diffraction, and/or optical, digital microscopy.

In some examples, the plurality of discrete emulsion droplets have an average droplet size of 0.1 micrometers (microns, μm) or more (e.g., 0.25 μm or more, 0.5 μm or more, 0.75 μm or more, 1 μm or more, 1.25 μm or more, 1.5 μm or more, 1.75 μm or more, 2 μm or more, 2.5 μm or more, 3 μm or more, 3.5 μm or more, 4 μm or more, 4.5 μm or more, 5 μm or more, 6 μm or more, 7 μm or more, 8 μm or more, 9 μm or more, 10 μm or more, 11 μm or more, 12 μm or more, 13 μm or more, 14 μm or more, 15 μm or more, 16 μm or more, 17 μm or more, 18 μm or more, 19 μm or more, 20 μm or more, 25 μm or more, 30 μm or more, 35 μm or more, 40 μm or more, 45 μm or more, 50 μm or more, 55 μm or more, 60 μm or more, 65 μm or more, 70 μm or more, 75 μm or more, 80 μm or more, 85 μm or more, 90 μm or more, or 95 μm or more). In some examples, the plurality of discrete emulsion droplets have an average droplet size of 100 μm or less (e.g., 95 μm or less, 90 μm or less, 85 μm or less, 80 μm or less, 75 μm or less, 70 μm or less, 65 μm or less, 60 μm or less, 55 μm or less, 50 μm or less, 45 μm or less, 40 μm or less, 35 μm or less, 30 μm or less, 25 μm or less, 20 μm or less, 19 μm or less, 18 μm or less, 17 μm or less, 16 μm or less, 15 μm or less, 14 μm or less, 13 μm or less, 12 μm or less, 11 μm or less, 10 μm or less, 9 μm or less, 8 μm or less, 7 μm or less, 6 μm or less, 5 μm or less, 4.5 μm or less, 4 μm or less, 3.5 μm or less, 3 μm or less, 2.5 μm or less, 2 μm or less, 1.75 μm or less, 1.5 μm or less, 1.25 μm or less, 0.75 μm or less, 0.5 μm or less, or 0.25 μm or less). The average droplet size of the plurality of discrete emulsion droplets can range from any of the minimum values described above to any of the maximum values described above. For example, the plurality of discrete emulsion droplets can have an average droplet size of from 0.1 micrometers (microns, μm) to 100 μm (e.g., from 0.1 μm to 50 μm, from 50 μm to 100 μm, from 0.1 μm to 20 μm, from 20 μm to 40 μm, from 40 μm to 60 μm, from 60 μm to 80 μm, from 80 μm to 100 μm, from 0.1 μm to 80 μm, from 0.1 μm to 60 μm, from 0.1 μm to 40 μm, from 0.1 μm to 10 μm, from 0.1 μm to 1 μm, from 0.5 μm to 100 μm, from 1 μm to 100 μm, from 10 μm to 100 μm, from 20 μm to 100 μm, from 40 μm to 100 μm, from 60 μm to 100 μm, from 0.25 μm to 80 μm, from 0.5 μm to 60 μm, from 0.75 μm to 40 μm, from 0.1 μm to 20 μm, or from 1 μm to 10 μm). In some examples, the plurality of discrete emulsion droplets have an average droplet size of from 1 to 100 μm. In some examples, the plurality of discrete emulsion droplets have an average droplet size of from 0.1 μm to 50 μm. the plurality of discrete emulsion droplets have an average droplet size of from 1 μm to 10 μm.

In some examples, the plurality of discrete emulsion droplets can be substantially monodisperse. “Monodisperse” and “homogeneous size distribution,” as used herein, and generally describe a population of droplets where all of the droplets are the same or nearly the same size. As used herein, a monodisperse distribution refers to droplet distributions in which 80% of the distribution (e.g., 85% of the distribution, 90% of the distribution, or 95% of the distribution) lies within 25% of the median droplet size (e.g., within 20% of the median droplet size, within 15% of the median droplet size, within 10% of the median droplet size, or within 5% of the median droplet size).

### Emulsifier

The emulsifier can comprise any suitable material, such as those known in the art. In some examples, the emulsifier comprises a surfactant. Suitable surfactants include sulfonated aromatic polymers (e.g., naphthalene sulfonates, sulfonated polystyrenes, sulfonated polyvinyltoluenes, and lignosulfonates); polyamines (e.g., polyalkylenepolyamines), and polyvinylalcohols.

The surfactant can include, for example, a non-ionic surfactant, an anionic surfactant, a cationic surfactant, a zwitterionic surfactant, or a combination thereof.

Suitable nonionic surfactants include, but are not limited to, polyoxyalkylene alkyl ethers and polyoxyalkylene alkylphenyl ethers (e.g., diethylene glycol monoethyl ether, diethylene glycol diethyl ether, polyoxyethylene lauryl ether, polyoxyethylene stearyl ether, polyoxyethylene nonylphenyl ether, and polyoxyethylene octyl phenyl ether available as Triton X-100); oxyethylene-oxypropylene block copolymers; sorbitan fatty acid esters (e.g., sorbitan monolaurate available as SPAN® 20 from Merck Schuchardt OHG, sorbitan monooleate available as SPAN® 80 from Merck Schuchardt OHG, and sorbitan trioleate available as SPAN® 85 from Merck Schuchardt OHG); polyoxyethylene sorbitan fatty acid esters (e.g., polyoxyethylene sorbitan monolaurate available as TWEEN® 20 and TWEEN® 21 from Uniqema, polyoxyethylene sorbitan monopalmitate available as TWEEN® 40 from Uniqema, polyoxyethylene sorbitan monostearate available as TWEEN® 60, TWEEN® 60K, and TWEEN® 61 from Uniqema, polyoxyethylene sorbitan monooleate available as TWEEN® 80, TWEEN® 80K, and TWEEN® 81 from Uniqema, and polyoxyethylene sorbitan trioleate available as TWEEN® 85 from Uniqema); polyoxyethylene sorbitol fatty acid esters (e.g., tetraoleic acid polyoxyethylene sorbitol); glycerin fatty acid esters (e.g., glycerol monooleate); polyoxyethylene glycerin fatty acid esters (e.g., monostearic acid polyoxyethylene glycerin and monooleic acid polyoxyethylene glycerin); polyoxyethylene fatty acid esters (e.g., polyethylene glycol monolaurate and polyethylene glycol monooleate); polyoxyethylene alkylamine; and acetylene glycols.

Suitable anionic surfactants include, but are not limited to, fatty acids, alkyl sulfates, alkyl ether sulfates, alkyl benzene sulfonic acid, alkyl phosphoric acid or salts thereof, and sucrose esters. Additional examples of anionic surfactants include, but are not limited to, ammonium lauryl sulfate, ammonium perfluorononanoate, docusate, perfluorobutanesulfonic acid, perfluorononanoic acid, perfluorooctanesulfonic acid, perfluorooctanoic acid, phospholipid, potassium lauryl sulfate, sodium dodecyl sulfate (SDS), sodium dodecylbenzenesulfonate, sodium laurate, sodium laureth sulfate, sodium lauroyl sarcosinate, sodium myreth sulfate, sodium pareth sulfate, sodium stearate, and combinations thereof.

In some examples, the surfactant is cationic, including primarily organic amines (e.g., primary, secondary, tertiary or quaternary amines). Examples of cationic amines include polyethoxylated oleyl/stearyl amine, ethoxylated tallow amine, cocoalkylamine, oleylamine, and tallow alkyl amine.

Examples of quaternary amines with a single long alkyl group are cetyl trimethyl ammonium bromide (“CTAB”), dodecyltrimethylammonium bromide, myristyl trimethyl ammonium bromide, stearyl dimethyl benzyl ammonium chloride, oleyl dimethyl benzyl ammonium chloride, lauryl trimethyl ammonium methosulfate (also known as cocotrimonium methosulfate), cetyl-dimethyl hydroxyethyl ammonium dihydrogen phosphate, bassuamidopropylkonium chloride, cocotrimonium chloride, distearyldimonium chloride, wheat germ-amidopropalkonium chloride, stearyl octyidimonium methosulfate, isostearaminopropal-konium chloride, dihydroxypropyl PEG-5 linoleammonium chloride, PEG-2 stearmonium chloride, behentrimonium chloride, dicetyl dimonium chloride, tallow trimonium chloride and behenamidopropyl ethyl dimonium ethosulfate.

Examples of quaternary amines with two long alkyl groups are distearyldimonium chloride, dicetyl dimonium chloride, stearyl octyldimonium methosulfate, dihydrogenated palmoylethyl hydroxyethylmonium methosulfate, dipalmitoylethyl hydroxyethylmonium methosulfate, diolcoylethyl hydroxyethylmonium methosulfate, and hydroxypropyl bisstearyldimonium chloride.

Quaternary ammonium compounds of imidazoline derivatives include, for example, isostearyl benzylimidonium chloride, cocoyl benzyl hydroxyethyl imidazolinium chloride, cocoyl hydroxyethylimidazolinium PG-chloride phosphate, and stearyl hydroxyethylimidonium chloride. Other heterocyclic quaternary ammonium compounds, such as dodecylpyridinium chloride, can also be used.

Suitable cationic surfactants include, but are not limited to, benzalkonium, polyQATs, quaternary ammonium compounds (e.g., CTAB), and combination thereof.

“Zwitterionic” or “zwitterion” as used herein refers to a neutral molecule with a positive (or cationic) and a negative (or anionic) electrical charge at different locations within the same molecule. In some examples, the surfactant is zwitterionic, which has both a formal positive and negative charge on the same molecule. The positive charge group can be quaternary ammonium, phosphonium, or sulfonium, whereas the negative charge group can be carboxylate, sulfonate, sulfate, phosphate or phosphonate. Example zwitterionic surfactants include betains and sultains.

Specific examples of zwitterionic surfactants include alkyl betaines such as cocodimethyl carboxymethyl betaine, lauryl dimethyl carboxymethyl betaine, lauryl dimethyl alpha-carboxyethyl betaine, cetyl dimethyl carboxymethyl betaine, lauryl bis-(2-hydroxyethyl) carboxy methyl betaine, stearyl bis-(2-hydroxypropyl) carboxymethyl betaine, olcyl dimethyl gamma-carboxypropyl betaine, and lauryl bis-(2-hydroxypropyl) alphacarboxy-ethyl betaine, amidopropyl betaines; and alkyl sultaines such as cocodimethyl sulfopropyl betaine, stearyidimethyl sulfopropyl betaine, lauryl dimethyl sulfoethyl betaine, lauryl bis-(2-hydroxyethyl) sulfopropyl betaine, and alkylamidopropylhydroxy sultaines.

Suitable zwitterionic surfactants include, but are not limited to, phospholipids, sulfobetaine, and combinations thereof.

In some examples, the emulsifier comprises a nonionic surfactant.

In some examples, the emulsifier comprises a detergent.

In some examples, the emulsifier comprises oleic acid, tetramethylammonium hydroxide, citric acid, soy lecithin, sodium stearoyl lactylate, triton X-100, sorbitan monolaurate, or a combination thereof.

In some examples, the emulsifier comprises soy lecithin, sodium stearoyl lactylate, triton X-100, sorbitan monolaurate, or a combination thereof.

In some examples, the emulsifier comprises a Pickering emulsifier, the Pickering emulsifier comprising a plurality of non-magnetic particles. Examples of Pickering emulsifiers are known in the art.

### Additives

In some examples, the magnetorheological emulsion can include one or more additional additives. For example, the magnetorheological emulsion can include fluid-loss additives, secondary viscosifiers, lubricants, solvents, dispersants, bridging solids, strength improving additives, retarders, accelerators, extenders, weighting agents, gases, expansive agents, corrosion reducing agents, oxidizing reducing agents, elastic behavior or creep-recovery enhancers (e.g., polymer beads) and combinations thereof.

### Methods of Making

Also disclosed herein are methods of making any of the magnetorheological emulsions disclosed herein.

For example, the methods can comprise dispersing the plurality of discrete emulsion droplets and the plurality of magnetic particles in the non-magnetic carrier fluid. The dispersing can comprise any suitable method, such as agitating. Agitating the can be accomplished, for example, by mechanical stirring, shaking, vortexing, sonication (e.g., bath sonication, probe sonication, ultrasonication), homogenizing (e.g., using a high shear homogenizer), and the like, or combinations thereof.

In some examples, the methods can comprise contacting the non-magnetic carrier fluid, the emulsifier, and the internal fluid phase to form a first composition; agitating the first composition to form a first dispersion comprising the plurality of discrete emulsion droplets dispersed in the non-magnetic carrier fluid (e.g., forming a first emulsion); contacting the plurality of magnetic particles with the first dispersion to form a second composition; and agitating the second composition to form the magnetorheological emulsion.

Agitating the first composition and/or the second composition can be accomplished using any suitable means. Agitating the can be accomplished, for example, by mechanical stirring, shaking, vortexing, sonication (e.g., bath sonication, probe sonication, ultrasonication), homogenizing (e.g., using a high shear homogenizer and/or a high pressure homogenizer), and the like, or combinations thereof. In some examples, agitating the first composition and/or the second composition comprises using a high shear homogenizer, a high pressure homogenizer, a vortex, or a combination thereof. In some examples, agitating the first composition comprises using a high shear homogenizer, a high pressure homogenizer, a vortex, or a combination thereof. In some examples, agitating the second composition comprises using a high shear homogenizer, a vortex, or a combination thereof.

In some examples, the first composition is agitated for an amount of time of 1 minute or more (e.g., 5 minutes or more, 10 minutes or more, 15 minutes or more, 20 minutes or more, 25 minutes or more, 30 minutes or more, 35 minutes or more, 40 minutes or more, 45 minutes or more, 50 minutes or more, or 55 minutes or more). In some examples, the first composition is agitated for an amount of time of 1 hour or less (e.g., 55 minutes or less, 50 minutes or less, 45 minutes or less, 40 minutes or less, 35 minutes or less, 30 minutes or less, 25 minutes or less, 20 minutes or less, 15 minutes or less, 10 minutes or less, or 5 minutes or less). The amount of time that the first composition is agitated can range from any do the minimum values described above to any of the maximum values described above. For example, the first composition can be agitated for an amount of time of from 1 minute to 1 hour (e.g., from 1 to 30 minutes, from 30 to 60 minutes, from 1 to 20 minutes, from 20 to 40 minutes, from 40 to 60 minutes, from 1 to 50 minutes, from 1 to 40 minutes, from 1 to 15 minutes, from 1 to 10 minutes, from 1 to 50 minutes, from 5 to 60 minutes, from 10 to 60 minutes, from 15 to 60 minutes, from 20 to 60 minutes, from 50 to 60 minutes, from 5 to 55 minutes, or from 10 to 50 minutes). In some examples, the first composition can be agitated for an amount of time of from 5 minutes to 1 hour.

In some examples, the second composition is agitated for an amount of time of 1 second or more (e.g., 5 seconds or more, 10 seconds or more, 15 seconds or more, 20 seconds or more, 25 seconds or more, 30 seconds or more, 35 seconds or more, 40 seconds or more, 45 seconds or more, 50 seconds or more, 55 seconds or more, 1 minute or more, 1.25 minutes or more, 1.5 minutes or more, 1.75 minutes or more, 2 minutes or more, 2.25 minutes or more, 2.5 minutes or more, 3 minutes or more, 3.5 minutes or more, 4 minutes or more, or 4.5 minutes or more). In some examples, the second composition is agitated for an amount of time of 5 minutes or less (e.g., 4.5 minutes or less, 4 minutes or less, 3.5 minutes or less, 3 minutes or less, 2.5 minutes or less, 2.25 minutes or less, 2 minutes or less, 1.75 minutes or less, 1.5 minutes or less, 1.25 minutes or less, 1 minute or less, 55 seconds or less, 50 seconds or less, 45 seconds or less, 40 seconds or less, 35 seconds or less, 30 seconds or less, 25 seconds or less, 20 seconds or less, 15 seconds or less, 10 seconds or less, or 5 seconds or less). The amount of time that the second composition is agitated can range from any of the minimum values described above to any of the maximum values described above. For example, the second composition can be agitated for an amount of time of from 1 second to 5 minutes (e.g., from 1 second to 2.5 minutes, from 2.5 minutes to 5 minutes, from 1 second to 1 minute, from 1 minute to 2 minutes, from 2 minutes to 3 minutes, from 3 minutes to 4 minutes, from 4 minutes to 5 minutes, from 1 second to 4 minutes, from 1 second to 3 minutes, from 1 second to 2 minutes, from 1 second to 45 seconds, from 1 second to 30 seconds, from 15 seconds to 5 minutes, from 30 seconds to 5 minutes, from 1 minute to 5 minutes, from 2 minutes to 5 minutes, from 3 minutes to 5 minutes, from 5 seconds to 4.5 minutes, from 10 seconds to 4 minutes). In some examples, the second composition is agitated for an amount of time of from 1 second to 1 minute, such as 30 seconds.

In some examples, the first composition is agitated for an amount of time of from 1 minute to 1 hour and the second composition is agitated for an amount of time of from 1 second to 5 minutes.

In some examples, the first composition is agitated for an amount of time of from 1 minute to 1 hour and the second composition is agitated for an amount of time of from 1 second to 1 minute.

In some examples, the first composition is agitated for an amount of time of from 5 minutes to 1 hour and the second composition is agitated for an amount of time of from 1 second to 5 minutes.

In some examples, the first composition is agitated for an amount of time of from 5 minutes to 1 hour and the second composition is agitated for an amount of time of from 1 second to 1 minute.

### Methods of Use

Also disclosed herein are methods of use of any of the magnetorheological emulsions described herein. For example, the method can comprise using the magnetorheological emulsion in a magnetorheological device (e.g., in place of a magnetorheological fluid).

In some examples, the method can comprise using the magnetorheological emulsion in an energy absorbers and dissipators, for example an earthquake damper, in an automobile, in a prosthetic (e.g., a prosthetic joint), in a robot, or a combination thereof.

In some examples, the method comprises using the magnetorheological emulsion in a magnetorheological damper, such as in an earthquake damper, a prosthetic device, a robotic device, or a combination thereof.

In some examples, the method comprises using the magnetorheological emulsion as a polishing liquid.

In some examples, the method comprises using magnetorheological emulsion in an actuator, such as in a robot or a robotic component.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Fluid Additives for Improving MRF Performance

Magnetorheological fluids (MRFs) are classically simple dispersions of magnetic particles in a non-magnetic carrier fluid. The magnetic particles are most commonly iron or iron oxide, although more exotic magnetic materials can be used depending the application, albeit at increased cost. The non-magnetic carrier fluid is typically mineral oil, silicone oil, or water, depending on the application.

MRFs have two unique states. Without a magnetic field (“off-state”) the dispersion has low viscosity and acts as a fluid with properties similar to the carrier fluid. When exposed to a magnetic field (“on-state”), the magnetic particles align with the field and form chains. The magnetized fluid increases in viscosity dramatically, acts more as a solid, and has a significant yield stress. In the “off-state” the MRF can, for example, behave as a Newtonian fluid, while in the “on-state” the MRF can transition to something that behaves more as a Bingham plastic.

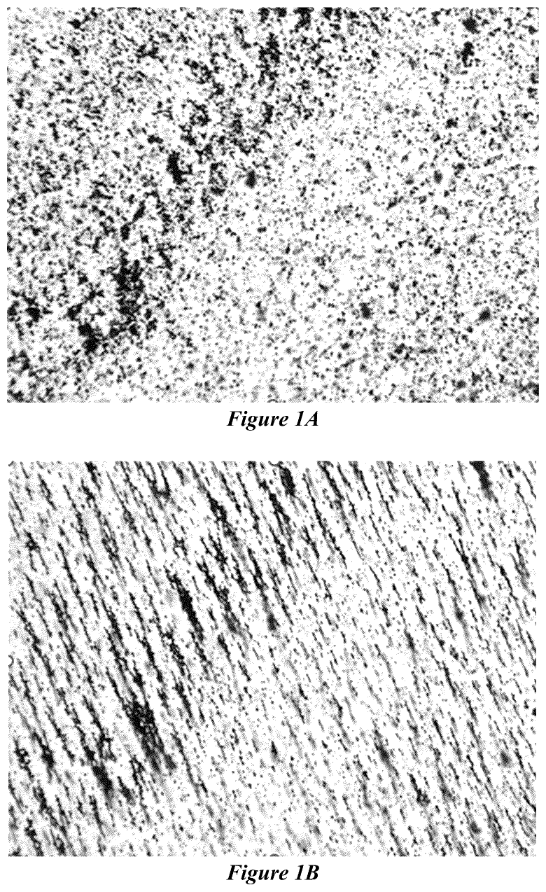

FIG. 1A shows an example MRF comprising a dispersion of iron in silicone oil in the “off-state.” When a magnetic field is applied using a bar magnet (neodymium magnet), the MRF quickly transitions to the “on-state”, where the iron particles align with the magnetic field to form chains, which can be observed in FIG. 1B, which causes the significant increase in yield stress.

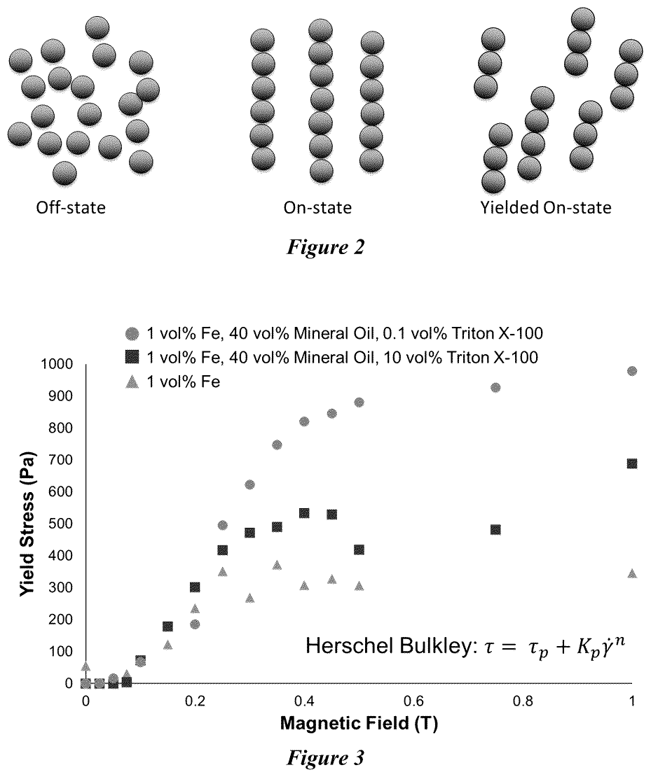

FIG. 2 schematically shows three states of MRFs, the “off-state” (left), the “on-state” (middle), and the “yielded on-state” (right). As previously discussed and shown in FIG. 1A, in the “off-state” (FIG. 2, left panel) the magnetic particles are randomly distributed in the carrier fluid. In the “on-state”, the magnetic particles align with the magnetic field and form chains (FIG. 2, middle panel; FIG. 1B). In the “on-state”, when a shear force is applied to an MRF, the chains resist breaking along the magnetic field lines, because they are attracted to each other due to the magnetic field. However, when sufficient force is applied, the chains yield (FIG. 2, right panel) and energy is dissipated as heat.

In the literature, as well as industrially, MRFs are often used in devices called “dampers” which effectively harness the resistance to shear to dissipate energy (via heat) safely through the fluid rather than via structural damage in a building, for example. One of the main current uses of MRFs is to use them for earthquake dampers (e.g., a damper with the MRFs is included in the walls of building, and used to dissipate seismic energy via heat instead of structural damage to the building).

Two key metrics used to evaluate MRF performance are: 1) the ratio of on-state to off-state viscosity; and 2) yield stress. The main ways to control this are: magnetic particle concentration, magnetic particle magnetization behavior, and magnetic field.

Controlling the magnetic particle concentration is easy, however, when the magnetic particle concentration is increased too much, there is also an increase in the “off-state” viscosity, which can be detrimental to parameter 1 above.

Particle magnetization behavior is based on selection of the magnetic material. However, more exotic magnetic materials with improved magnetic susceptibility are more expensive, therefore most published and practical work focuses on iron or iron oxide.

Magnetic field is also easy to control, and, unlike the other two parameters, this can be controlled after the MRF has been fabricated. As such, much of the work in MRFs to date has been in damper design and control schemes (Zhu X, Jing X, Cheng L. Journal of Intelligent Material Systems and Structures. 2012; 23 (8): 839-873). These still rely on controlling and increasing magnetic field to achieve MRF performance.

The magnetic field in an MRF damper is typically applied via an embedded inductor coil requiring a power supply (Zhu X, Jing X, Cheng L. Journal of Intelligent Material Systems and Structures. 2012; 23 (8): 839-873). For large systems (e.g., for earthquake dampers), this power requirement can be steep. In an emergency situation (e.g., during an earthquake), this high amount of required power may not be available. If there is not enough power available, the MRF cannot be transitioned to the “on-state” and therefore becomes useless. For small systems, if the power source must be worn/transported (e.g., prosthetics), the required power source may be cumbersome or dangerous. As such, safer and cheaper methods of achieving requisite performance of MRFs are needed.

As described herein, the use of fluid additives to increase yield stress in the on-state without requiring additional power were investigated. Specifically, it was discovered that the inclusion of discrete emulsion droplets in the MRF increases yield stress in the on state without significantly increasing the viscosity in the off state.

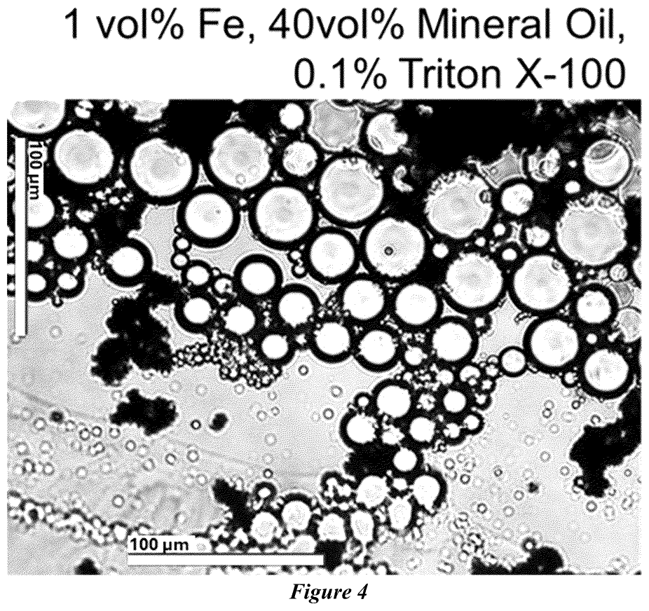

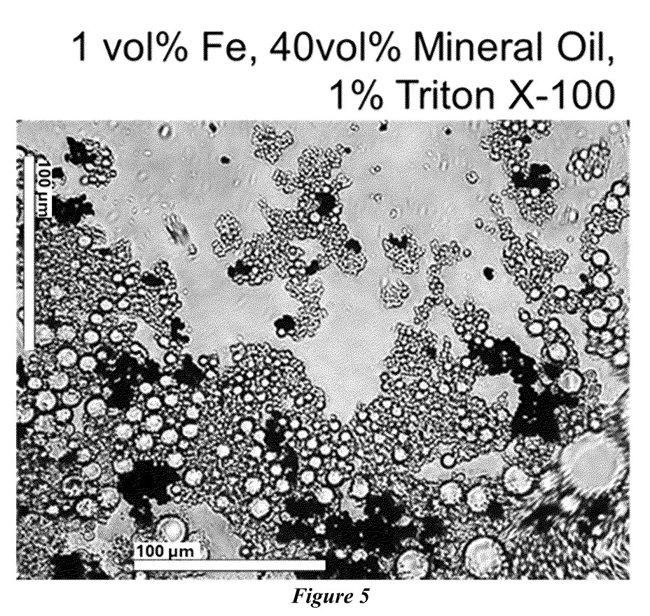

FIG. 3 shows the yield stress of three samples vs. magnetic field. The first sample (triangles in FIG. 3) is just a neat iron dispersion in water (e.g., a standard MRF). The other two samples (squares and circles in FIG. 3) are MRFs with discrete emulsion droplets formed using Triton X-100; where one of the emulsion samples (squares in FIG. 3) has small emulsion droplets (FIG. 5) and the other emulsion sample (circles in FIG. 3) has larger emulsion droplets (FIG. 4). As can be seen in FIG. 3, the yield stress increases significantly when emulsions are added to the MRFs. As such, the yield stress can be improved significantly by including the discrete emulsion droplets without needing to increase the magnetic field strength.

Emulsions are simple systems that have been used for millennia and studied for centuries. MRFs have been studied from about a century. However, to date, this is the first study utilizing discrete emulsion droplets as an MRF additive.

There have been previous studies that have investigated adding the magnetic particles into emulsion droplets themselves, however these studies provided no improved performance and no interesting changes.

The behavior of the MRFs with discrete emulsion droplets shown herein is non-intuitive. One of ordinary skill in the art would likely think that the magnetic particles would simply pierce the discrete emulsion interface, causing the emulsion to collapse. However, that is not what has been observed herein. Instead, it was observed that this increase in yield stress is not only repeatable but tunable.

Emulsions are inexpensive, both in terms of materials and fabrication. Emulsions are already made on industrial scales, so the methods of fabrication are known to be readily scalable and the industry is comfortable with the technology. MREms (MRFs with discrete emulsion droplets) can be used as a drop-in technology to any existing damper system. No new device fabrication is needed. MREms require less power to achieve the same yield stress for a given amount of magnetic material.

This research focuses on understanding what are the specific emulsion parameters that lead to an increase in yield stress. Fundamental research is being done in aqueous emulsions for simplicity, but knowledge will be transferrable to oil-based systems. Emulsion stability is an important parameter for marketability and is addressable (based on the current state of industry).

Applications of these MREms (MRFs including emulsion droplets) include dampers, prosthetics, and robotics.

### Example 2—Fluid Additives for Improving MRF Performance

Magnetorheological fluids (MRFs) are commonly simple suspensions of magnetic particles in a non-magnetic carrier fluid. Most often these are suspensions of iron in silicone or mineral oil. MRFs are unique in their ability to quickly transition from a liquid to almost solid-like state upon the application of an external magnetic field. Utilizing this transition, MRFs can be used as energy absorbers and dissipators for reducing the damage of an earthquake, reducing vibration in an automobile, or reducing impact and discomfort in a prosthetic joint. MRFs have great promise in the fields of robotics and prosthetics but haven't found full translation into these markets due to challenges related to the energy requirements of the material. In order to improve MRF performance, specifically increase the final viscosity or yield stress of the MRF, the simplest method is to increase magnetic field. However, increasing magnetic field requires greater power, which may be unavailable during an earthquake or may necessitate carrying large and even dangerous power sources for a prosthetic. New methods are needed to reduce the power requirement of MRFs while still achieving their impressive performance. Current strategies include new damper designs, new control algorithms, or new (and more expensive) magnetic materials. Meanwhile, herein the continuous phase of the MRF is targeted and the jamming phenomenon is used to improve the MRF effect at lower power levels. This is achieved by using emulsions in the continuous phase; a method that has never been previously explored and would likely have been assumed to fail by those well versed in the fields of magnetic composites or emulsions. However, it was unexpectedly found that the yield stress of MRFs can be improved by including emulsion droplets (termed MREms) while maintaining the same magnetic field. Emulsions are inexpensive and simple to make, making this an attractive way of moving MRFs to greater commercial realization.

MREms are able to achieve great magnetic performance, i.e., greater yield stresses, at the same magnetic fields as the neat iron MRFs. This means that the MREms, for very little increase in cost or complexity in terms of material fabrication, are cheaper, more reliable, and safer to operate than their MRF counterparts.

MRFs have great promise in earthquake dampers, prosthetic joints, and robotic manipulators if they can be made reliable, inexpensive, and safe. MREms are uniquely positioned to achieve these goals with a minimum of increased complexity or addition of new chemicals/additives.

### Example 3—Assembly Mechanism Investigation and Theoretical Framework Development of Magnetorheological Emulsions for Low Power Energy Dampers

Energy dissipation is a ubiquitous process that allows buildings to withstand wind and the human body to move through the environment. Under optimal conditions, structural materials can dissipate the energy of bending, impact, or vibration without any deleterious effects. When conditions are no longer optimal, however, standard materials may be insufficient or unavailable. For example, while buildings and bridges built from steel and concrete are able to support large populations, the United States alone loses $4.4 billion annually due to earthquake damage; and globally, from 2005-2015, more than 400,000 people died as a result of earthquakes (US Geological Survey, Global death toll due to earthquakes from 2000 to 2015. Statista: 2016). On the level of the human body, cartilage is connective tissue that allows for the dissipation of impact energy on individual joints. A healthy person exerts forces 2.5-2.8 times their body weight on their knees just when walking (D'Lima D D et al. Proc Inst Mech Eng H 2012, 226 (2), 95-102). As it is expected that the number of people in the U.S. needing prosthetics will double between 2005 and 2050 due to vascular disease alone (Ziegler-Graham K et al. Arch Phys Med Rehabil 2008, 89 (3), 422-9), it is important that those who have prosthetic limbs and have lost their natural cartilaginous energy dissipation have alternative ways to protect residual bones and muscles. In those situations where energy dissipation is needed, new systems, such as viscous dampers, can be used.

Viscous dampers comprise dashpots filled with a viscous fluid. These passive dampers dissipate energy when the viscous fluid flows through an orifice, around a piston, or across/between surfaces (Miyamoto H K et al. Earthquake Engineering & Structural Dynamics 2010, 39 (11), 1279-1297; Jiuhong J et al. Archive of Applied Mechanics 2008, 78 (9), 737-746). Passive dampers, however, are static systems that cannot respond dynamically to changing vibrations or impact due to variable seismic activity, structural resonance, or noise (Bagherkhani A et al. Probabilistic Engineering Mechanics 2021, 63, 103114). To overcome the static limitations, active (or semi-active) dampers add a control system that allows for dynamic energy dissipation. Magnetorheological fluids (MRFs), when used in a viscous damper system, allow for a wide range of energy dissipation with precise control via tuning of an applied magnetic field (Zhu X et al. Journal of Intelligent Material Systems and Structures 2012, 23 (8), 839-873; de Vicente J et al. Soft Matter 2011, 7 (8), 3701-3710). MRFs are dispersions of magnetic particles in a non-magnetic continuous phase. When a magnetic field is applied, the magnetic particles form chains and resist deformation, as expressed in increased viscosity and yield stress. MRFs have already been shown to improve energy dissipation in earthquake dampers and prosthetic joints, but they have significant limitations that have hampered their widespread adoption (Thiagarajan S et al. Advanced Engineering Materials 2021, 2001458). One challenge is their large device power requirement as the magnetic field is commonly generated through induction coils, and larger current yields a larger magnetic field and a higher performing MRF (Leps T et al. Smart Materials and Structures 2020, 29 (10), 105025; Olabi A G et al. Materials & Design 2007, 28 (10), 2658-2664; Kumar J S et al. International Journal of Mechanical and Materials Engineering 2019, 14 (1), 13). Unfortunately, high power demands are either infeasible, such as during an earthquake when power lines and power plants are often out of service, or unsafe, as power sources for prosthetics that must be worn on the body. To overcome this limitation, the work described herein seeks to develop a new magnetorheological fluid that takes advantage of an emulsion continuous phase (MREm) to increase MRF performance at lower magnetic fields. The magnetic field and the induced assembly of magnetic particles can induce a jamming transition in the emulsion, which improves yield stress. With the success of this work, MRF dampers can enable access to safer infrastructure and better prosthetics with less power and greater reliability, resulting in improved quality of life and reduced disaster economic burden.

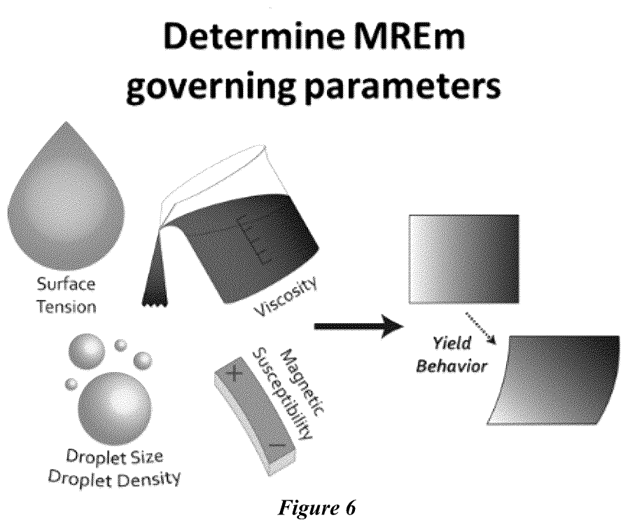

Determine the key fluidic and magnetic parameters governing MREm performance (FIG. 6). Work described herein above has indicated that an emulsion continuous phase can greatly improve the yield stress of an MRF without needing to increase the magnetic field. As there are many parameters that govern the behavior of either emulsions or MRFs (e.g., surface tension, viscosity, droplet size density, magnetic susceptibility, yield behavior), experiments can be performed to determine which are the most important factors that define MREm behavior. In this work, the governing parameters, based on the critical dimensionless numbers that describe emulsion and MRF behavior, are explored. Results of this work can only allow future work to better tune MREm performance and also indicate whether jamming is the mechanism of improvement.

The results of this work can directly impact the health and quality of life of both U.S. and global citizens who either live in seismically active regions or need the aid of a prosthetic limb. The knowledge generated in this work can dramatically move the state of the art in dampening technology forward as well as the fundamental understanding of rigid-deformable interparticle interactions, particularly in active systems.

Background and Current Research. Magnetorheological fluids (MRFs) are dispersions of magnetic particles, commonly iron, in a non-conductive carrier fluid (e.g., silicone, mineral oil, water) (Thiagarajan S et al. Advanced Engineering Materials 2021, 2001458). Since the initial development of MRFs in 1948 (Rabinow J. Stand. Tech. News Bull 1948, 4, 54-60), these “smart” fluids have been studied for the absorption and safe dissipation (or dampening) of energy in applications such as earthquake dampers and prosthetic joints (Kumar J S et al. International Journal of Mechanical and Materials Engineering 2019, 14 (1), 13; Lenggana B W et al. Applied Sciences 2021, 11 (19), 9339; Carlson J D et al. Smart prosthetics based on magnetorheological fluids. SPIE: 2001; Vol. 4332). Energy dissipation occurs due to a magnetically induced orientation and assembly of magnetic particles from ‘randomly dispersed’ to chains aligned to the external field with strong dipole-dipole particle interactions. Chain alignment occurs in milliseconds and is largely reversible. The magnetic chains resist deformation, particularly under shear, which is quantified via viscosity. The “MR effect” specifically refers to the ratio of on-state (magnetic field applied) to off-state (no magnetic field) viscosities or modulus (Thiagarajan S et al. Advanced Engineering Materials 2021, 2001458). When a magnetic field is applied and the particles form chains the MRF also exhibits a yield stress, which describes the stress required to shear and break the chains. Optimal MRFs have a high ratio of on-state to off-state viscosity and a high yield stress.

A large body of work has attempted to increase the MR effect and MRF yield stress in order to better dissipate impact and seismic energy (Thiagarajan S et al. Advanced Engineering Materials 2021, 2001458; Lenggana B W et al. Applied Sciences 2021, 11 (19), 9339; Ashtiani M et al. Journal of Magnetism and Magnetic Materials 2015, 374, 716-730; Cruze D et al. Civil Engineering Journal 2018, 4 (12), 3058-3074; Xic Y et al. Earthquake Spectra 2020, 36 (4), 1769-1801). Improvements have generally come in three varieties: new control methods, new damper devices, and new MRF formulation. Engineering MRF formulation is a powerful method for improving performance in a non-application specific way. New MRF formulations have studied how to improve the response of the material to magnetic field by increasing magnetic material concentration, changing continuous phase viscosity, studying the effect of particle shape and size, and using new magnetic materials (Thiagarajan S et al. Advanced Engineering Materials 2021, 2001458; Ashtiani M et al. Journal of Magnetism and Magnetic Materials 2015, 374, 716-730). Essentially, these strategies attempt to have a larger yield stress or on-state/off-state viscosity ratio at lower magnetic fields by using materials that have higher magnetic susceptibility, organize into stronger structures, or have a higher inherent mechanical strength. As the most common way to generate a magnetic field for an MRF is through an inductive coil, which requires a constant flow of electricity, a lower magnetic field means a lower power requirement. This is vital for MRF applications, particularly earthquake dampers and prosthetics, as power needed may be unavailable or unsafe.

Unfortunately, current MRF strategies either significantly increase costs or lead to high off-state viscosity, hysteresis, and a reduced difference between on-state and off-state viscosity. This work, alternatively, seeks to increase MR performance by adding a non-magnetic particle phase to the continuous fluid. Previous studies using added rigid non-magnetizable particles have effectively increased on-state viscosity and yield stress. However, there is no conclusive, generalizable mechanism for the MR improvement. Rodríguez-Arco et al. reported adsorption of iron onto PMMA particles resulting in increased magnetic permeability (Rodríguez-Arco L et al. Soft Matter 2013, 9 (24), 5726-5737). Later work by the same group suggests that in another PMMA/iron dispersion, collisions between magnetic and non-magnetic particles which increase hydrodynamic dissipation and diffusional stress increase yield stress (Rodríguez-Arco L et al. Physical Review E 2014, 90 (1), 012310). Another explanation used by Cates et al. (Cates M E et al. Physical Review Letters 1998, 81 (9), 1841-1844) and Wilson et al. (Wilson B T et al. Journal of Rheology 2017, 61 (4), 601-611) ascribes increases in yield stress to force transfer between magnetic and non-magnetic particles (called “force chains” by Wilson (Wilson B T et al. Journal of Rheology 2017, 61 (4), 601-611)) rather than a change in magnetic chain microstructure as hypothesized by Rodríguez-Arco (Rodríguez-Arco L et al. Soft Matter 2013, 9 (24), 5726-5737; Rodríguez-Arco L et al. Physical Review E 2014, 90 (1), 012310).

Rather than looking at rigid non-magnetizable particles, which have the negative side effects of increased off-state viscosity and bulk modulus in addition to inconclusive mechanisms, this work focuses on a much less studied fluid composite: magnetic particles and emulsion droplets. Emulsion droplets are surfactant-stabilized spheres of a liquid that are immiscible in the bulk continuous phase. There is a wealth of previous work studying the rheological behavior of emulsions (Pal R. Colloid and Polymer Science 1999, 277 (6), 583-588; Princen H et al. Journal of colloid and interface science 1989, 128 (1), 176-187; Rosen M J et al. Surfactants and interfacial phenomena. John Wiley & Sons: 2012; Pal R et al. Current Opinion in Colloid & Interface Science 2011, 16 (1), 41-60). While most emulsions show some type of shear thinning behavior, high internal phase emulsions and emulsions with strong interdroplet interaction display significant yield stresses due to rearrangement of droplet aggregation. This has been used extensively by the food industry (Fuhrmann P L et al. Food Hydrocolloids 2019, 97, 105215; Rousseau D et al. Food Research International 2000, 33 (1), 3-14; Zhu Y et al. Journal of Texture Studies 2020, 51 (1), 45-55) and by environmental engineers as a remediation technique (Zhao C et al. Science of The Total Environment 2021, 765, 142795; Jiang X et al. Environmental Science and Pollution Research 2021, 28 (34), 46934-46963; El-Gaayda J et al. Journal of Environmental Chemical Engineering 2021, 9 (5), 106060).

Emulsion droplets are inherently deformable inclusions that have a significantly reduced impact on composite off-state viscosity as compared to rigid particles. Previous work has looked at using magnetic particles encapsulated in emulsion droplets or embedded in emulsion interfaces for environmental and pharmaceutical applications (Zhu Y et al. Journal of Environmental Sciences 2020, 88, 217-236; Tang J et al. Soft Matter 2015, 11 (18), 3512-3529; Low L E et al. International Journal of Biological Macromolecules 2019, 127, 76-84), but little has been done to understand how emulsion droplets can participate in MRF performance as discrete bodies. For example, work in emulsified ferrofluids has demonstrated complex rheology and the ability to form various chain structures that can be used as electrodes, but this work treats the assembly of the ferrofluid and the assembly of the emulsions as one and the same (Li L et al. Advanced Energy Materials 2019, 9 (2), 1802472; Ivey M et al. Physical Review E 2000, 63 (1), 011403). This is highlighted by the deformation and stretching of emulsion droplets caused by magnetic field alignment that has been visualized previously in the literature (Montagne F et al. Journal of Magnetism and Magnetic Materials 2002, 250, 302-312; Zakinyan A R et al. Journal of Magnetism and Magnetic Materials 2017, 431, 103-106). One study that did look at emulsions discrete from iron was done by Park et al. who found that using a water-in-oil emulsion reduces iron particle sedimentation, a common problem in MRFs due to the low density continuous phase (Park J H et al. Journal of Colloid and Interface Science 2001, 240 (1), 349-354). They found that the emulsions had little impact on fluid rheology (Park J H et al. Journal of Colloid and Interface Science 2001, 240 (1), 349-354). Their work had no discussion of the interaction between magnetic particles and emulsion droplets other than that magnetic chains were not negatively impacted (Park J H et al. Journal of Colloid and Interface Science 2001, 240 (1), 349-354).

The lack of impact on MRF rheology due to emulsions droplets may be expected, as none of the hypothesized mechanisms of rigid non-magnetizable/magnetizable particle interactions should be applicable to emulsion droplets. As fluid inclusions, the droplets are not expected to effectively participate in force transfer or particle-particle collisions that increase magnetic particle hydrodynamic diffusion. Particle-emulsion aggregation is possible but would require specific system formulation and would likely result in magnetic Pickering emulsions. However, magnetic Pickering emulsions, or emulsions stabilized by magnetic particles, have been found to be detrimental to MRF performance (Chac H S et al. Macromolecular Chemistry and Physics 2018, 219 (5), 1700408).

Contrary to Park et al. and the inapplicability of the existing non-magnetizable/magnetizable particle interaction mechanisms to emulsions, the work herein suggests that emulsion droplets dispersed in an MRF have a significant impact on MRF on-state yield behavior. The magnetorheology of two MRF emulsions (MREms) and the comparable MRF were fit to the Herschel-Bulkley equation to determine plastic yield stress (τp). As shown in FIG. 3, there is an increase in MRF yield stress when emulsion droplets are included. The two MREms have 40 vol % mineral oil with either 10 vol % or 0.1 vol % Triton X-100 as surfactant, and all three MRFs were in water with 1 vol % iron. Not only does the presence of emulsion droplets increase the yield stress, but droplet size is proven to be a significant contributor (0.1 vol % Triton X-100 has larger droplets and a larger yield stress) to the MR performance. The comparison between 0.1 and 10 vol % of Triton X-100 and the corresponding droplet size difference agrees with emulsion literature (Pal R. J Colloid Interface Sci 2000, 225 (2), 359-366).

By utilizing emulsion droplets and engineering their formulation and interfacial properties it should be possible to strategically design MRF performance. It is hypothesized that deformable particle jamming is the mechanism by which emulsion droplets are interacting with and improving MRF yield stress. Jamming is an actuation method extensively studied for rigid particles (Jorjadze I et al. Proceedings of the National Academy of Sciences 2011, 108 (11), 4286-4291; Song C et al. Nature 2008, 453 (7195), 629-632; Steltz E et al. Jamming as an enabling technology for soft robotics. SPIE: 2010; Vol. 7642; Bi et al. Nature 2011, 480 (7377), 355-358). For emulsions, jamming is largely studied in highly concentrated systems (Ikeda A et al. Physical Review Letters 2012, 109 (1), 018301; Zhang H P et al. Physical Review E 2005, 72 (1), 011301; Ikeda A et al. Soft Matter 2013, 9 (32), 7669-7683; Clusel M et al. Nature 2009, 460 (7255), 611-615). One mechanism by which emulsion jamming may induce increased yield stress in MREms is that the ordering of magnetic chains may increase the excluded volume of the system. This would then increase the local concentration of emulsions, the local viscosity, and the bulk yield stress. The strength of this excluded volume phenomena would be directly dependent on the strength of magnetic particle interactions, such that the increased local emulsion concentration would increase with increased magnetic field. Investigating why and how the emulsions improve MRF yield behavior and potential emulsion jamming requires not only an understanding of the balance of viscous to magnetic forces, which is a typical framework for MRFs with respect to the Bingham number and the Mason number (Furst E M et al. Physical Review E 2000, 61 (6), 6732-6739; Sherman S G et al. Journal of Magnetism and Magnetic Materials 2015, 380, 98-104), but also the unique contribution of the emulsion droplets to viscous forces that is unexpectedly field dependent. The work can investigate the interaction between emulsion droplets and magnetic particles that result in improved MR performance and elucidate the interaction mechanism.

This work seeks to understand the mechanisms by which emulsions improve magnetorheological performance. It is hypothesized that emulsion jamming and the subsequent increase in local concentration and viscosity is a responsible aggregation/assembly behavior.

The key fluidic and magnetic parameters that underpin MREm performance will be determined in order to focus on just those variables that lead to improved rheological performance.

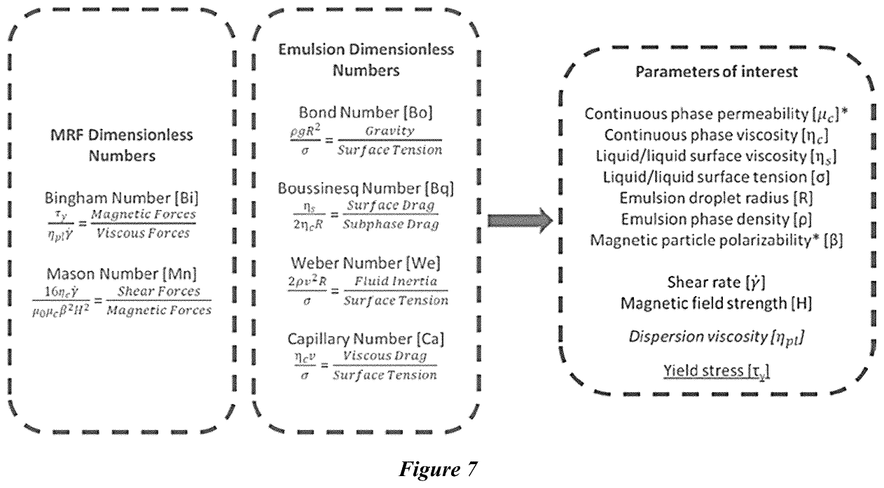

Dispersions of inclusions in a continuous phase have been studied extensively for decades in the case of responsive fluids and for centuries in the case of non-responsive fluids. As such, descriptions of the fundamental forces driving the fluid behavior have been developed that allow for a relatively simple understanding of key performance drivers (Ruzicka M C. Chemical Engineering Research and Design 2008, 86 (8), 835-868). One of the most powerful ways of expressing these key performance drivers is dimensionless numbers. Emulsions and MRFs have dimensionless numbers ascribed to them that describe the balance between forces such as surface tension, inertia, drag, and magnetism. FIG. 7 shows the key dimensionless numbers that describe emulsion behavior (Bhamla M S et al. Soft Matter 2014, 10 (36), 6917-6925; Thijssen J H J et al. Journal of Physics: Condensed Matter 2017, 30 (2), 023002), MRF behavior (Sherman S G et al. Journal of Magnetism and Magnetic Materials 2015, 380, 98-104), and the system variables that are used in either static or sheared systems. It is hypothesized that one or more of these parameters, derived from the dimensionless numbers that are characteristically used to describe MRF and emulsion behavior, will be the key parameter(s) governing MREm performance. The parameters that are found to be key drivers of MREm performance will indicate whether emulsion jamming is the mechanism of MR improvement as hypothesized. Magnetic particle polarizability can be kept constant by only using iron. The continuous phase permeability can also be held constant, as common MRF continuous phases (water, silicone oil, and mineral oil) have similar and negligible permeabilities.

The magnetorheological performance will be quantified as the MREm yield stress and the ratio of on-state to off-state viscosity (ηₒₙ/η_{off}). Target values vary as a function of magnetic particle concentration, but all MREms should outperform the corresponding MRF to be considered successful. The parameters of interest are grouped into three categories. First, yield stress will be used as a target value and not varied independently. Second, shear rate and magnetic field strength (\dot{γ} and H) are instrument parameters and will be varied for every formulation identically (\dot{γ}=0.1-250 l/s and H=0-1 T). Third, emulsion and dispersion formulation parameters cannot be entirely varied independently. In order to evaluate the unique impact of each emulsion/dispersion parameter the following formulation experimental design will be implemented:

Elucidating oil/water surface tension: As the outcomes of emulsification, including droplet size and emulsion viscosity, rely on surface tension, equilibrium and dynamic surface behavior will be examined. Three different oil systems with three different densities and surface tension values (oil properties shown in Table 1) will be used as the disperse phase in a de-ionized water continuous phase. Triton X-100 will be used as the surfactant to stabilize oil/water interfaces. The equilibrium surface tension data will be used to determine Γ_{eq}, i.e., the adsorbed surfactant concentration at interfacial saturation (Rosen M J et al. Surfactants and interfacial phenomena. John Wiley & Sons: 2012; Koh A et al. Langmuir 2017, 33 (23), 5760-5768). This indicates the concentration (per unit area) above which surface tension will not change at the liquid/liquid interface. The dynamic surface tension data will be used to calculate an adsorption rate (Rosen M J et al. Surfactants and interfacial phenomena. John Wiley & Sons: 2012), which indicates how long emulsions should be mixed in order for adsorption to not be rate limiting. Equilibrium and dynamic surface tension will be measured using pendant drop tensiometry.

TABLE 1
Fluid properties for oil dispersed phases.

| | Density | O/W Surface Tension |
|---|---|---|
| | (ρ, g/mL) | (σ, m/m) |
| Almond oil | 0.91 | 26 |
| Mineral Oil | 0.838 | 55.5 |
| Decane | 0.73 | 51 |

Examining the effect of ρ and R: Emulsions of 40 vol % oil will be made with surfactant concentrations 2*Γ_{eq} assuming an average droplet size of 1 μm. This is expected to be a lower bound of emulsion droplet sizes, and thus the emulsion interface is always expected to be saturated and surface tension will be constant. Emulsions will be mixed with a high shear homogenizer and mixing times will be varied in order to vary emulsion droplet size (e.g., 5 minutes to 1 hour). Mixing times will all be sufficiently long to minimize adsorption rate limitations. Target emulsion droplet sizes will range between 100 and 1 μm. To the emulsion, 1 vol % iron will be mixed, and the MREm magnetorheology will be evaluated. When keeping the oil constant and varying emulsion droplet size, the impact of R will be evaluated independent of all other parameters. In order to determine the impact of ρ, MREm with similar droplet sizes and equilibrium surface tension values will be compared across different oils. If emulsion jamming is the mechanism of yield improvement, as is hypothesized, it is expected that droplet size will have a significant impact on MR behavior (as was seen in FIG. 3), and that smaller droplets will lead to greater yield stresses (Dinkgreve M et al. Physical Review Letters 2018, 121 (22), 228001; Tripathi S et al. Chemical Engineering Science 2017, 174, 290-301). While higher density oils may lead to reduced droplet deformation and increased yield stress, little work has been done investigating the effect of dispersed phase density on emulsion jamming.

Examining the effect of σ: Emulsions of 40 vol % oil will be made similar to those above, but emulsions will be made with concentrations with 5%-75% of Γ_{eq}. Changing surfactant concentration below Γ_{eq} is expected to increase surface tension and increase emulsion droplet sizes (Hu Y et al. Physical review letters 2003, 91 (4), 044501). To emulsions of each oil, 1 vol % iron will be added (using a vortex mixer for 30 seconds), and the MREm magnetorheology will be evaluated. As the magnitude of the effect of emulsion droplet size will have been previously determined, these experiments are expected to target the impact of surface tension on MREm performance. Additionally, MREm with similar droplet sizes will be compared across oils to confirm the effect of surface tension as well as density. If emulsion jamming is the mechanism of yield improvement, as is hypothesized, it is expected that increasing surface tension will lead to an increased yield stress, as increased surface tension increases the force required to deform an emulsion droplet (Shu R et al. Colloids and Surfaces A: Physicochemical and Engineering Aspects 2013, 434, 220-228; Cao C et al. Soft Matter 2021, 17 (9), 2587-2595).

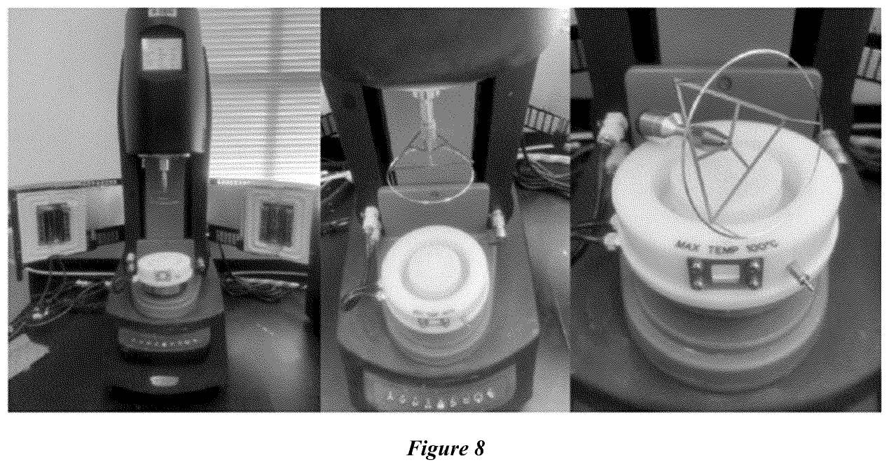

Examining the effect of ηₛ: Interfacial viscosity has never been studied as a factor impacting MRF performance despite the importance of flow across the magnetic particles. To study the impact of ηₛ on MREm performance, the interfacial viscosity must be first measured as a function of surfactant concentration. This will be done using a double wall Du Noüy ring rheometer fixture positioned at the water interface, as seen in FIG. 8. Surfactant will be introduced into the water phase (concentrations ranging from 5%-200% of Γ_{eq}), allowed to equilibrate at the interface, and viscosity will be subsequently measured. Interfacial viscosity will be measured at two types of interfaces. First, a platinum ring will be used to directly interrogate the oil/water interface (using all three oils shown in Table 1). Secondly, a plastic ring sputter coated with a thin layer of iron will be used at the air/water interface with the same concentrations of surfactant as described previously. This will enable interrogation of the impact of subphase surfactant concentration on viscous drag along the iron particle surface. The interfacial viscosity values generated in this task will be used to interrogate the effect of surface drag on the MREm performance. The connection between interfacial viscosity and emulsion jamming is not fully understood. For example, interfacial elasticity is known to have a strong impact on bulk emulsion yield behavior, but there is no universal behavior (Shu R et al. Colloids and Surfaces A: Physicochemical and Engineering Aspects 2013, 434, 220-228; Cao C et al. Rheology finds distinct glass and jamming transitions in emulsions. Soft Matter 2021, 17 (9), 2587-2595). However, it is known that stronger attraction at droplet interfaces, or generally greater adhesion, is correlated with greater jamming (Jorjadze I et al. Proceedings of the National Academy of Sciences 2011, 108 (11), 4286-4291; Sanatkaran N et al. Rheology of macro- and nano-emulsions in the presence of micellar depletion attraction. Journal of Rheology 2021, 65 (3), 453-461). Greater adhesion would manifest as greater interfacial viscosity. Thus, it is expected if emulsion jamming is the cause of improved yield behavior, as hypothesized, increased ηₛ will lead to increased yield stresses.

Examining the effect of η_{c}: Emulsions of 40 vol % oil will be made similar to those above at a single surfactant concentration (2*Γ_{eq}). Only mineral oil will be used to keep surface tension and density constant. In order to vary the continuous phase viscosity, sodium alginate will be added to the de-ionized water before the emulsion is made. Previous work has shown that sodium alginate can dramatically increase the viscosity of water (Guo X et al. International Journal of Biological Macromolecules 2020, 162, 618-628; Pignolet L H et al. Journal of Chemical Education 1998, 75 (11), 1430). Based on published work, it is assumed that the surfactant concentration (2*Γ_{eq}) will be sufficiently high such that the effect of sodium alginate on surface tension is expected to be negligible (Del Gaudio P et al. International journal of pharmaceutics 2005, 302, 1-9). Target η_{c} values are 1-1000 cP using sodium alginate concentrations up to 1 wt %. Continuous phase viscosity is expected to impact emulsion droplet sizes (as η_{c} increases R is expected to increase (Carrillo De Hert S et al. Chemical Engineering Science 2017, 172, 423-433)), so emulsions will be mixed for a sufficiently long time to all reach an average droplet size of 5 μm. To each emulsion, 1 vol % of iron will be added (using a vortex mixer for 30 sec), and the MREm magnetorheology will be evaluated. Similar to the effect of surface tension, if, as hypothesized, emulsion jamming is the mechanism of yield improvement, then increasing ne should increase yield stress as a higher continuous viscosity will increase the forces required to deform emulsion droplets. This is balanced, however, by the increased energy needed to aggregate, due to greater restriction in flow, such that at low magnetic fields the increased yield stress may not be apparent.

Examining the effect of ηₚₗ: The final emulsion/dispersion parameter that must be systematically evaluated is ηₚₗ, which is the effective, plastic viscosity of the complete MREm. MREm ηₚₗ is a function of all of the parameters studied above in addition to emulsion concentration (oil phase concentration) and magnetic particle concentration. In order to keep all other parameters constant, emulsions of 40 vol % mineral oil and one surfactant concentration (2*Γ_{eq}) will be made and then diluted to emulsion concentrations ranging from 1-30 vol %. To these emulsions, 1 vol % of iron will be added. One additional emulsion concentration will be studied at 65 vol %, which is just above the maximum packing fraction for rigid spheres (Wilken S et al. Physical Review Letters 2021, 127 (3), 038002), although emulsions can exceed this through droplet shape deformation (Masalova I et al. Colloids and Surfaces A: Physicochemical and Engineering Aspects 2011, 375 (1), 76-86). Surfactant concentration will be maintained at the same level as 40 vol % emulsions and emulsion mixing time will be altered to best match the 40 vol % emulsion droplet size. This concentration is expected to specifically target jamming as the MREm yield improvement mechanism, as 65 vol % is expected to be sufficiently packed that additional jamming should have minimal impact. Additionally, emulsions of 40 vol % mineral oil and a concentration of surfactant equal to 2*Γ_{eq} will be blended with 1-25 vol % iron. This range is based on previous work (Thiagarajan S et al. IEEE Transactions on Magnetics 2021, 57 (12), 1-8) that demonstrates (a) this is a feasible range of concentrations to fabricate and (b) that in a non-emulsion continuous phase particle concentration and particle magnetic susceptibility are the dominant factors in MR behavior (Thiagarajan S et al. IEEE Transactions on Magnetics 2021, 57 (12), 1-8). Increasing magnetic particle concentration as well as emulsion concentration is expected to increase ηₚₗ. Emulsions of varying oil concentration and iron particle concentration will be subsequently magnetorhcologically evaluated. As ηₚₗ increases, it is expected the forces required to deform emulsion droplets, as well as break up emulsion droplet aggregates, will increase. This will lead to increased yield stress if emulsion jamming is the mechanism of yield improvement as hypothesized. However, the correlation between ηₚₗ and yield stress is likely to be non-linear, as it is expected that at very large ηₚₗ it is likely that emulsion droplet aggregation into jammed structures will be impeded. Thus, the yield behavior of MREm is expected to be significantly dependent on ηₚₗ but not in as straightforward a manner as other variables.

Potential Challenges and Alternative Solutions: The greatest challenge of the work discussed in above is the interdependency of the parameters of interest. A standard design of experiments is not applicable to variables that cannot be independently varied, so each parameter must be well understood prior to emulsification in order to be held constant such that a single variable can be studied at a time. The evaluation of surface tension and the evaluation of continuous phase viscosity will be particularly challenging as both surface tension and continuous phase viscosity can have dramatic impacts on emulsion droplet size, which is another parameter of interest. While the work performed in elucidating oil/water surface tension will give a clear description of the impact of emulsion droplet size, the impact of synergism with either σ or η_{c} cannot be discounted. While comparing across oils (i.e., emulsions with different dispersed oil phases) or mixing times can enable direct comparison between emulsions with similar droplet sizes, if these variables are not sufficient to give a clear picture of the independent effect of σ or η_{c} additional surfactants will be employed (e.g., PEG-based surfactants or cetyl trimethyl ammonium bromide) to maintain droplet size at a particular σ or η_{c}.

Additionally, interfacial viscosity and interfacial tension cannot be independently evaluated as they are both a function of the same liquid/liquid interfacial parameters. As such, the relative magnitudes of MREm input (i.e., how big is the difference in interfacial viscosity or surface tension) must be compared to the magnitude of change of the outputs (yield stress and ηₒₙ/η_{off}) to determine which input has a greater impact.

### Example 4

The O/W emulsions are made by mixing water, almond oil, and Triton X-100 for a determined amount of time and speed based on targets size and volume of sample. Iron particles are weighed and added to the emulsion sample then mixed by hand to incorporate.

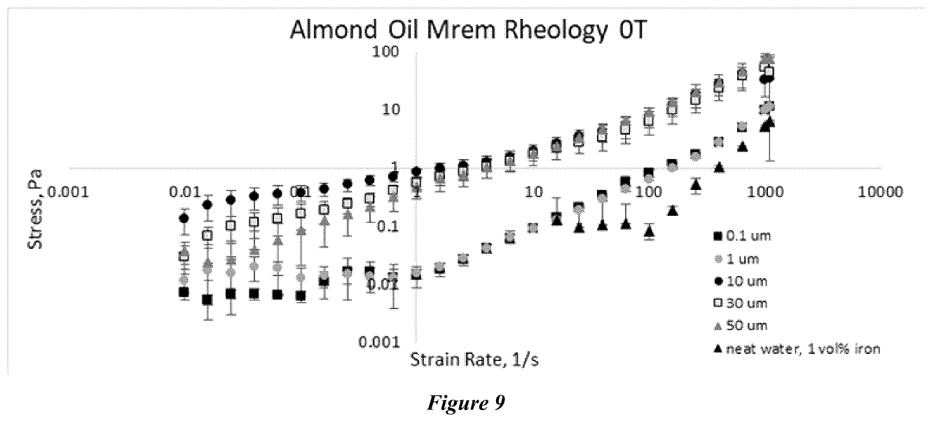

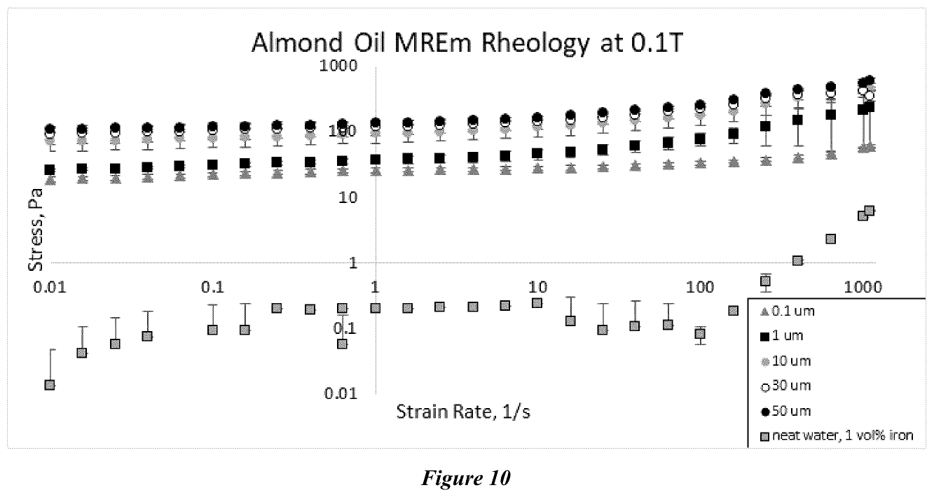

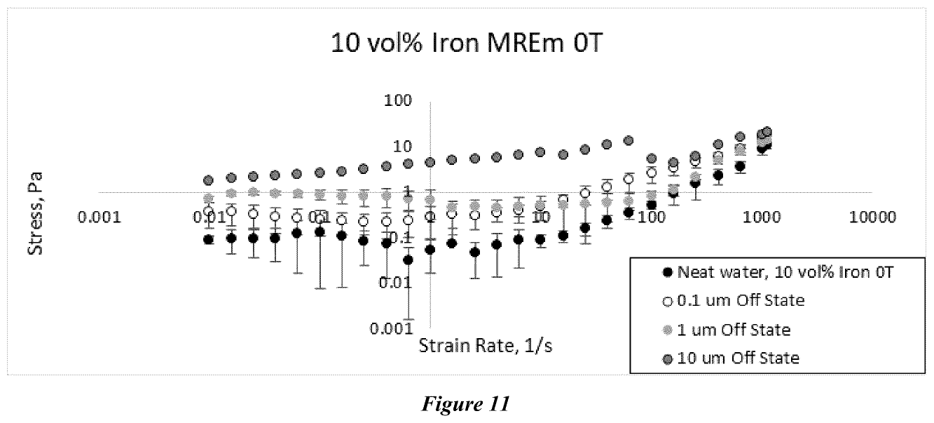

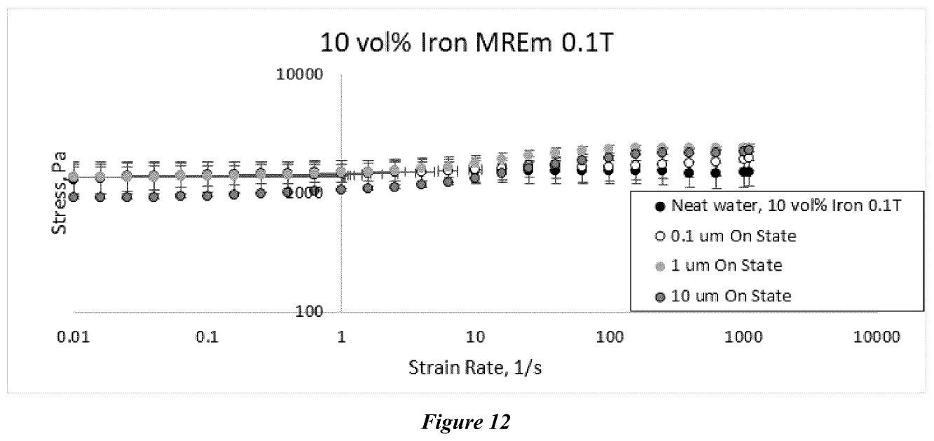

The results show that an increase in the emulsion droplet size (0.1-50 micron diameter) has an increase in the resulting shear strength, both when demagnetized and magnetized to 0.1 Tesla (FIG. 9-FIG. 10). As the fraction of iron increases, so does the shear strength (FIG. 11-FIG. 12). At higher iron concentrations the effect of the emulsion is reduced (FIG. 11-FIG. 12).

### EXEMPLARY ASPECTS

In view of the described porous polyether-ether-ketone (PEEK) scaffolds and methods of making and use thereof, herein below are described certain more particularly described aspects of the inventions. The particularly recited aspects should not, however, be interpreted to have any limiting effect on any different claims containing different or more general teachings described herein or that the “particular” aspects are somehow limited in some way other than the inherent meanings of the language and formulas literally used therein.
Example 1: A magnetorheological emulsion comprising: a magnetorheological fluid comprising a plurality of magnetic particles dispersed in a non-magnetic carrier fluid; and a plurality of discrete emulsion droplets dispersed in the non-magnetic carrier fluid; wherein each of the plurality of discrete emulsion droplets comprises an emulsifier encapsulating an internal fluid phase; wherein the internal fluid phase and the non-magnetic carrier fluid are immiscible. Example 2: The magnetorheological emulsion of any examples herein, particularly example 1, wherein the magnetorheological emulsion comprises: from greater than 0 to less than 100 vol % of the non-magnetic carrier fluid; from greater than 0 to 25 vol % of the plurality of magnetic particles; from greater than 0 to 25 vol % of the emulsifier; and from greater than 0 to less than 100 vol % of the internal fluid phase.
Example 3: The magnetorheological emulsion of any examples herein, particularly example 1 or example 2, wherein the magnetorheological emulsion comprises from 0.1 to 2.5 vol %, such as 1 vol %, of the plurality of magnetic particles.
Example 4: The magnetorheological emulsion of any examples herein, particularly examples 1-3, wherein the magnetorheological emulsion comprises from 0.1 to 10 vol % of the emulsifier.
Example 5: The magnetorheological emulsion of any examples herein, particularly examples 1-4, wherein the magnetorheological emulsion comprises from 10 to 80 vol %, such as 40 vol %, of the internal fluid phase.
Example 6: The magnetorheological emulsion of any examples herein, particularly examples 1-5, wherein the magnetorheological emulsion comprises: from greater than 0 to less than 100 vol % of the non-magnetic carrier fluid; from 0.1 to 2.5 vol %, such as 1 vol %, of the plurality of magnetic particles; from greater than 0 to 25 vol % of the emulsifier; and from greater than 0 to less than 100 vol % of the internal fluid phase.
Example 7: The magnetorheological emulsion of any examples herein, particularly examples 1-6, wherein the magnetorheological emulsion comprises: from greater than 0 to less than 100 vol % of the non-magnetic carrier fluid; from greater than 0 to 25 vol % of the plurality of magnetic particles; from 0.1 to 10 vol % of the emulsifier; and from greater than 0 to less than 100 vol % of the internal fluid phase.
Example 8: The magnetorheological emulsion of any examples herein, particularly examples 1-7, wherein the magnetorheological emulsion comprises: from greater than 0 to less than 100 vol % of the non-magnetic carrier fluid; from greater than 0 to 25 vol % of the plurality of magnetic particles; from greater than 0 to 25 vol % of the emulsifier; and from 10 to 80 vol %, such as 40 vol %, of the internal fluid phase.
Example 9: The magnetorheological emulsion of any examples herein, particularly examples 1-8, wherein the magnetorheological emulsion comprises: from greater than 0 to less than 100 vol % of the non-magnetic carrier fluid; from 0.1 to 2.5 vol %, such as 1 vol %, of the plurality of magnetic particles; from 0.1 to 10 vol % of the emulsifier; and from greater than 0 to less than 100 vol % of the internal fluid phase.
Example 10: The magnetorheological emulsion of any examples herein, particularly examples 1-9, wherein the magnetorheological emulsion comprises: from greater than 0 to less than 100 vol % of the non-magnetic carrier fluid; from 0.1 to 2.5 vol %, such as 1 vol %, of the plurality of magnetic particles; from greater than 0 to 25 vol % of the emulsifier; and from 10 to 80 vol %, such as 40 vol %, of the internal fluid phase.
Example 11: The magnetorheological emulsion of any examples herein, particularly examples 1-10, wherein the magnetorheological emulsion comprises: from greater than 0 to less than 100 vol % of the non-magnetic carrier fluid; from greater than 0 to 25 vol % of the plurality of magnetic particles; from 0.1 to 10 vol % of the emulsifier; and from 10 to 80 vol %, such as 40 vol %, of the internal fluid phase.
Example 12: The magnetorheological emulsion of any examples herein, particularly examples 1-11, wherein the magnetorheological emulsion comprises: from greater than 0 to less than 100 vol % of the non-magnetic carrier fluid; from 0.1 to 2.5 vol %, such as 1 vol %, of the plurality of magnetic particles; from 0.1 to 10 vol % of the emulsifier; and from 10 to 80 vol %, such as 40 vol %, of the internal fluid phase.
Example 13: The magnetorheological emulsion of any examples herein, particularly examples 1-12, wherein the plurality of magnetic particles comprise iron.
Example 14: The magnetorheological emulsion of any examples herein, particularly examples 1-13, wherein the plurality of magnetic particles comprise an iron oxide.
Example 15: The magnetorheological emulsion of any examples herein, particularly examples 1-14, wherein the plurality of magnetic particles are substantially spherical in shape.
Example 16: The magnetorheological emulsion of any examples herein, particularly examples 1-15, wherein the plurality of magnetic particles have an average particle size of from 0.01 to 100 micrometers.
Example 17: The magnetorheological emulsion of any examples herein, particularly examples 1-16, wherein the non-magnetic carrier fluid comprises mineral oil, almond oil, decane, silicone oil, or water.
Example 18: The magnetorheological emulsion of any examples herein, particularly examples 1-17, wherein the non-magnetic carrier fluid comprises mineral oil, silicone oil, or water.
Example 19: The magnetorheological emulsion of any examples herein, particularly examples 1-18, wherein the non-magnetic carrier fluid can have a fluid viscosity of from 0.9 cP to 1×10⁶ cP.
Example 20: The magnetorheological emulsion of any examples herein, particularly examples 1-19, wherein the internal fluid phase comprises mineral oil, almond oil, decane, silicone oil, limonene, or water.
Example 21: The magnetorheological emulsion of any examples herein, particularly examples 1-20, wherein the internal fluid phase comprises mineral oil, silicone oil, or water.
Example 22: The magnetorheological emulsion of any examples herein, particularly examples 1-21, wherein the non-magnetic carrier fluid comprises water and the internal fluid phase comprises mineral oil and/or silicone oil.
Example 23: The magnetorheological emulsion of any examples herein, particularly examples 1-21, wherein the non-magnetic carrier fluid comprises mineral oil and/or silicone oil and the internal fluid phase comprises water.
Example 24: The magnetorheological emulsion of any examples herein, particularly examples 1-23, wherein the plurality of discrete emulsion droplets have an average droplet size of from 0.1 micrometers (microns, μm) to 100 μm, such as from 1 to 100 μm.
Example 25: The magnetorheological emulsion of any examples herein, particularly examples 1-24, wherein the plurality of discrete emulsion droplets have an average droplet size of from 0.1 μm to 50 μm, such as from 1 μm to 10 μm.
Example 26: The magnetorheological emulsion of any examples herein, particularly examples 1-25, wherein the emulsifier comprises a surfactant.
Example 27: The magnetorheological emulsion of any examples herein, particularly examples 1-26, wherein the emulsifier comprises a nonionic surfactant.
Example 28: The magnetorheological emulsion of any examples herein, particularly examples 1-27, wherein the emulsifier comprises a detergent.
Example 29: The magnetorheological emulsion of any examples herein, particularly examples 1-28, wherein the emulsifier comprises soy lecithin, sodium stearoyl lactylate, triton X-100, sorbitan monolaurate, or a combination thereof.
Example 30: The magnetorheological emulsion of any examples herein, particularly examples 1-25, wherein the emulsifier comprises a Pickering emulsifier, the Pickering emulsifier comprising a plurality of non-magnetic particles.
Example 31: The magnetorheological emulsion of any examples herein, particularly examples 1-30, wherein, in the presence of a magnetic field, the magnetorheological emulsion exhibits a yield stress that is greater than the yield stress of the magnetorheological fluid in the absence of the plurality of discrete emulsion droplets under conditions that are otherwise the same.
Example 32: The magnetorheological emulsion of any examples herein, particularly examples 1-31, in the absence of a magnetic field, the magnetorheological emulsion has a fluid viscosity of from 0.9 cP to 1×106 cP.
Example 33: A method of use of the magnetorheological emulsion of any examples herein, particularly examples 1-32.
Example 34: The method of any examples herein, particularly example 33, wherein the method comprises using the magnetorheological emulsion in a magnetorheological device (e.g., in place of a magnetorheological fluid).
Example 35: The method of any examples herein, particularly example 33 or example 34, wherein the method comprises using the magnetorheological emulsion in a magnetorheological damper, such as in an earthquake damper, a prosthetic device, a robotic device, or a combination thereof.
Example 36: The method of any examples herein, particularly examples 33-35, wherein the method comprises using the magnetorheological emulsion in an actuator, such as in a robot or a robotic component.
Example 37: A method of making the magnetorheological emulsion of any examples herein, particularly examples 1-32.
Example 38: The method of any examples herein, particularly example 37, wherein the method comprises dispersing the plurality of discrete emulsion droplets and the plurality of magnetic particles in the non-magnetic carrier fluid.
Example 39: The method of any examples herein, particularly example 37 or example 38, wherein the method comprises: contacting the non-magnetic carrier fluid, the emulsifier, and the internal fluid phase to form a first composition; agitating the first composition to form a first dispersion comprising the plurality of discrete emulsion droplets dispersed in the non-magnetic carrier fluid (e.g., a first emulsion); contacting the plurality of magnetic particles with the first dispersion to form a second composition; and agitating the second composition to form the magnetorheological emulsion.
Example 40: The method of any examples herein, particularly example 39, wherein agitating the first composition and/or the second composition comprises using a high shear homogenizer, a vortex, or a combination thereof.
Example 41: The method of any examples herein, particularly example 39 or example 40, wherein the first composition is agitated for an amount of time of from 1 minute to 1 hour, such as from 5 minutes to 1 hour.
Example 42: The method of any examples herein, particularly examples 39-41, wherein the second composition is agitated for an amount of time of from 1 second to 5 minutes, such as 30 seconds.
Example 43: The method of any examples herein, particularly examples 39-42, wherein the first composition is agitated for an amount of time of from 1 minute to 1 hour, such as from 5 minutes to 1 hour, and the second composition is agitated for an amount of time of from 1 second to 5 minutes, such as 30 seconds.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

What is claimed is:

1. A magnetorheological emulsion comprising:
a magnetorheological fluid comprising a plurality of magnetic particles dispersed in a non-magnetic carrier fluid; and
a plurality of discrete emulsion droplets dispersed in the non-magnetic carrier fluid;
wherein each of the plurality of discrete emulsion droplets comprises an emulsifier encapsulating an internal fluid phase;
wherein the internal fluid phase and the non-magnetic carrier fluid are immiscible.

2. The magnetorheological emulsion of claim 1, wherein the magnetorheological emulsion comprises:
from greater than 0 to less than 100 vol % of the non-magnetic carrier fluid;
from greater than 0 to 25 vol % of the plurality of magnetic particles;
from greater than 0 to 25 vol % of the emulsifier; and
from greater than 0 to less than 100 vol % of the internal fluid phase.

3. The magnetorheological emulsion of claim 1, wherein the magnetorheological emulsion comprises from 0.1 to 2.5 vol % of the plurality of magnetic particles.

4. The magnetorheological emulsion of claim 1, wherein the magnetorheological emulsion comprises from 0.1 to 10 vol % of the emulsifier.

5. The magnetorheological emulsion of claim 1, wherein the magnetorheological emulsion comprises from 10 to 80 vol % of the internal fluid phase.

6. The magnetorheological emulsion of claim 1, wherein the plurality of magnetic particles have an average particle size of from 0.01 to 100 micrometers.

7. The magnetorheological emulsion of claim 1, wherein the non-magnetic carrier fluid comprises mineral oil, almond oil, decane, silicone oil, or water.

8. The magnetorheological emulsion of claim 1, wherein the non-magnetic carrier fluid has a fluid viscosity of from 0.9 cP to 1×10⁶ cP.

9. The magnetorheological emulsion of claim 1, wherein the internal fluid phase comprises mineral oil, almond oil, decane, silicone oil, limonene, or water.

10. The magnetorheological emulsion of claim 1, wherein the non-magnetic carrier fluid comprises water and the internal fluid phase comprises mineral oil and/or silicone oil.

11. The magnetorheological emulsion of claim 1, wherein the non-magnetic carrier fluid comprises mineral oil and/or silicone oil and the internal fluid phase comprises water.

12. The magnetorheological emulsion of claim 1, wherein the plurality of discrete emulsion droplets have an average droplet size of from 0.1 micrometers (microns, μm) to 100 μm.

13. The magnetorheological emulsion of claim 1, wherein the emulsifier comprises a surfactant.

14. The magnetorheological emulsion of claim 1, wherein the emulsifier comprises a detergent.

15. The magnetorheological emulsion of claim 1, wherein the emulsifier comprises soy lecithin, sodium stearoyl lactylate, triton X-100, sorbitan monolaurate, or a combination thereof.

16. The magnetorheological emulsion of claim 1, wherein the emulsifier comprises a Pickering emulsifier, the Pickering emulsifier comprising a plurality of non-magnetic particles.

17. The magnetorheological emulsion of claim 1, wherein, in the presence of a magnetic field, the magnetorheological emulsion exhibits a yield stress that is greater than the yield stress of the magnetorheological fluid in the absence of the plurality of discrete emulsion droplets under conditions that are otherwise the same.

18. The magnetorheological emulsion of claim 1, in the absence of a magnetic field, the magnetorheological emulsion has a fluid viscosity of from 0.9 cP to 1×10⁶ cP.

19. A method of use of the magnetorheological emulsion of claim 1, wherein the method comprises using the magnetorheological emulsion in a magnetorheological device.

20. A method of making the magnetorheological emulsion of claim 1, wherein the method comprises dispersing the plurality of discrete emulsion droplets and the plurality of magnetic particles in the non-magnetic carrier fluid.
